(19) United States
(12) Patent Application Publication
(10) Pub. No.: US 2026/0106981 A1
(43) Pub. Date: Apr. 16, 2026

(54) ENCODING METHOD, DECODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/420,029

(22) Filed: Dec. 15, 2025

Related U.S. Application Data
(63) Continuation of application No. PCT/CN2023/101156, filed on Jun. 19, 2023.

(51) Int. Cl. H04N 19/117; H04N 19/159; H04N 19/176; H04N 19/196; H04N 19/82

(52) U.S. Cl. CPC H04N 19/117; H04N 19/159; H04N 19/176; H04N 19/196; H04N 19/82

(57) ABSTRACT

Embodiments of the present application disclose an encoding method, a decoding method, and a storage medium. The decoding method, applied to a decoder, includes: decoding a bitstream, and determining a target filtering mode for a current block; determining a reference area for the current block on the basis of a size parameter of the current block and the target filtering mode; determining filter coefficients for the current block on the basis of the reference area for the current block; and performing intra prediction on the current block on the basis of the filter coefficients, and determining predicted values of the current block.

### CROSS-REFERENCE TO RELATED APPLICATION

The present application is a continuation of International Application No. PCT/CN2023/101156 filed on Jun. 19, 2023, the disclosure of which is hereby incorporated by reference in its entirety.

### BACKGROUND

With the improvement of people's requirements for video display quality, high-resolution videos such as high-definition videos and ultra-high-definition videos have emerged. However, high-resolution video typically has more information and therefore requires more bandwidth. To reduce bandwidth requirements, video coding standards involving video compression have been introduced.

Currently, an intra-prediction technique based on interpolation has been proposed in video coding standards. Specifically, interpolation filtering coefficients are obtained by using reconstructed sample values around a current block, and then used to perform intra-prediction on the current block. However, existing technical schemes still have some defects, which make the ratio of the performance of coding and decoding to time complexity low.

### SUMMARY

Embodiments of the present application relate to the technical field of video encoding and decoding, and more particularly to an encoding and decoding method, and a storage medium.

The technical solution of the embodiments of the present application can be implemented as follows.

According to a first aspect, an embodiment of the present application provides a decoding method applied to a decoder, the method includes the following operations:
A bitstream is decoded to determine a target filtering mode for the current block;
A reference region for the current block is determined according to a size parameter of the current block and the target filtering mode;
Filtering coefficients for the current block is determined according to the reference region for the current block; and
Intra prediction is performed on the current block according to the filtering coefficients, to determine prediction values of the current block.

According to a second aspect, an embodiment of the present application provides an encoding method applied to an encoder, the method includes the following operations:
A target filtering mode for the current block is determined;
A reference region for the current block is determined according to a size parameter of the current block and the target filtering mode;
Filtering coefficients for the current block are determined according to the reference region for the current block; and
Intra prediction is performed on the current block according to the filtering coefficients, to determine prediction values of the current block.

In a third aspect, an embodiment of the present application provides a non-transitory computer-readable storage medium, having a computer program and a bitstream stored thereon, the computer program, when executed by a processor, enables the processor to perform the method according to the second aspect to generate the bitstream.

### BRIEF DESCRIPTION OF THE DRAWINGS

FIG. 1A is a first schematic diagram of a calculation method for obtaining a value m.

FIG. 1B is a second schematic diagram of a calculation method for obtaining a value m.

FIG. 1C is a third schematic diagram of a calculation method for obtaining a value m.

FIG. 2A is a first schematic diagram of a positional relationship between a current block and a reconstructed region.

FIG. 2B is a second schematic diagram of a positional relationship between a current block and a reconstructed region.

FIG. 2C is a third schematic diagram of a positional relationship between a current block and a reconstructed region.

FIG. 3A is a first schematic diagram of the shape of an interpolation filter.

FIG. 3B is a second schematic diagram of the shape of an interpolation filter.

FIG. 3C is a third schematic view of the shape of an interpolation filter.

FIG. 4 is a schematic diagram of a structure for obtaining inputs and outputs at possible positions of an interpolation filter.

FIG. 5 is a schematic diagram of an interpolation filtering-based prediction direction.

FIG. 6 is a schematic diagram of an angular mode for intra prediction.

FIG. 7 is a schematic diagram of a 3×3 window sliding in a prediction block.

FIG. 8 is a schematic diagram of accumulated gradient amplitude values in a different angular direction.

FIG. 9A is a schematic block diagram of a configuration of an encoder according to an embodiment of the present application.

FIG. 9B is a schematic block diagram of a configuration of a decoder according to an embodiment of the present application.

FIG. 10 is a schematic diagram of a network architecture of a codec system according to an embodiment of the present application.

FIG. 11 is a first schematic flowchart of a decoding method according to an embodiment of the present application.

FIG. 12A is a first schematic diagram of a reference region for a current block according to an embodiment of the present application.

FIG. 12B is a second schematic diagram of a reference region for a current block according to an embodiment of the present application.

FIG. 12C is a third schematic diagram of a reference region for a current block according to an embodiment of the present application.

FIG. 13 is a second schematic flowchart of a decoding method according to an embodiment of the present application.

FIG. 14A is a first schematic diagram showing a distribution of linear terms and nonlinear terms of a target filter according to an embodiment of the present application.

FIG. 14B is a second schematic diagram showing a distribution of linear terms and nonlinear terms of an interpolation filter according to an embodiment of the present application.

FIG. 14C is a third schematic diagram showing a distribution of linear terms and nonlinear terms of an interpolation filter according to an embodiment of the present application.

FIG. 15A is a first schematic diagram showing a distribution of linear terms and nonlinear terms of another target filter according to an embodiment of the present application.

FIG. 15B is a second schematic diagram showing a distribution of linear terms and nonlinear terms of another interpolation filter according to the embodiment of the present application.

FIG. 15C is a third schematic diagram showing a distribution of linear terms and nonlinear terms of another interpolation filter according to the embodiment of the present application.

FIG. 16A is a first schematic diagram showing a distribution of linear terms and nonlinear terms of still another target filter according to an embodiment of the present application.

FIG. 16B is a second schematic diagram showing a distribution of linear terms and nonlinear terms of still another interpolation filter according to the embodiment of the present application.

FIG. 16C is a third schematic diagram showing a distribution of linear terms and nonlinear terms of another interpolation filter according to the embodiment of the present application.

FIG. 17 is a first schematic flowchart of an encoding method according to an embodiment of the present application.

FIG. 18A is a first schematic diagram of division of a reference region according to an embodiment of the present application.

FIG. 18B is a second schematic diagram of division of a reference region according to an embodiment of the present application.

FIG. 18C is a third schematic diagram of division of a reference region according to an embodiment of the present application.

FIG. 19 is a second schematic flowchart of an encoding method according to an embodiment of the present application.

FIG. 20 is a schematic structural diagram of a configuration of an encoder according to an embodiment of the present application.

FIG. 21 is a schematic diagram of a specific hardware structure of an encoder according to an embodiment of the present application.

FIG. 22 is a schematic structural diagram of a configuration of a decoder according to an embodiment of the present application.

FIG. 23 is a schematic diagram of a specific hardware structure of a decoder according to an embodiment of the present application.

FIG. 24 is a schematic structural diagram of a configuration of an encoding and decoding system according to an embodiment of the present application.

### DETAILED DESCRIPTION

In order to provide a more detailed understanding of the features and technical contents of embodiments of the present application, implementation of the embodiments of the present application will be described in detail below with reference to the accompanying drawings, which are for reference and illustration only, and are not intended to limit the embodiments of the present application.

Unless otherwise defined, all technical and scientific terms used herein have the same meaning as commonly understood by those skilled in the art belonging to the present application. The terminology used herein is for the purpose of describing the embodiments of the present application only and is not intended to limit the present application.

In the following description, reference is made to “some embodiments”, which describes a subset of all possible embodiments, but it will be understood that “some embodiments” may be the same subset or different subsets of all possible embodiments, which may be combined with each other without conflict.

It should also be pointed out that the terms “first”, “second”, and “third” referred to in the embodiments of the present application are only used to distinguish similar objects, and do not represent a specific ordering for the objects, and it is understood that “first”, “second”, and “third” may be interchanged for a specific order or priority order where allowed, so that the embodiments of the present application described herein can be implemented in an order other than that illustrated or described herein.

Before further describing the embodiments of the present application, words and terms involved in the embodiments of the present application will be described first, and the words and terms involved in the embodiments of the present application are applicable to the following explanations:
Joint Video Experts Group JVET;
H.266/Versatile Video Coding (VVC);
VVC Test Model (VTM);
Enhanced Compression Mode (ECM);
Interpolation Filtering-based Intra Prediction (Extrapolation Intra Prediction (EIP));
Multiple Transform Selection (MTS);
Discrete Cosine Transform (DCT);
Discrete Sine Transform (DST);
Non-Separable Primary Transform (NSPT);
Low Frequency Non-separable Secondary Transform (LFNST);
Direct Current (DC) mode;
PLANAR mode (PLANAR);
Direct Mode (DM);
Intra Block Copy (IBC);
Wide Angle Intra Prediction (WAIP);
Sum of Squares for Error (SSE);
Mean Squared Error (MSE);
Sum of Absolute Difference (SAD).

It is appreciated that the interpolation-based intra-prediction technique refers to a technique in which coefficients of interpolation filter are obtained from reconstructed sample values around a current block for intra-prediction of the current block. Specifically, the interpolation filtering-based intra prediction technique may include one or more of the following features:
(a) A number of taps of the interpolation filter should be greater than or equal to 2, the interpolation filter may have a variety of shapes, and the shape of a selected interpolation filter is controlled using syntax elements.
(b) Reconstructed samples used to obtain the coefficients of the interpolation filter should be within one or several regions around the current block, and a region used to obtain the coefficients of the interpolation filter is selected using the syntax elements.
(c) Interpolation filtering prediction may use intra blocks in luma or chroma for prediction.
(d) When Interpolation filtering prediction is used for the current block, the prediction should be performed in a certain order from the top left corner to the lower right corner of the block.
(e) The input of the interpolation filter is reconstructed sample values and/or predicted sample values, or may be reconstructed values and prediction values subtracted from a certain value.
(f) When a value is subtracted from the input of the interpolation filter, corresponding to (e), the interpolation result should add this value back.
(g) Maximum and minimum values may be acquired from the reconstructed sample values around the current block, which are used to define the output range of the interpolation filter.

Further, interpolation filtering-based specific intra prediction techniques can be described in detail through the following aspects.

### (1) Obtain Mean, Minimum and Maximum Values.

In one possible embodiment, the maximum and minimum values of the reconstructed samples are found in a reconstructed region of 13 rows and 13 columns around the current block, where the maximum and minimum values can be used to limit the range of prediction results.

In one possible embodiment, m which is subtracted from the input of the interpolation filter and is added to the output of the interpolation filter is obtained according to the following method, m is a value used for DC mode prediction and m is a positive integer.

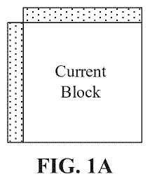

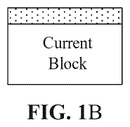

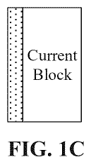

Exemplarily, taking FIGS. 1A, 1B, and 1C as examples, the calculation method of obtaining the value m here can be divided into three cases:
(i) When a width of a current block is equal to a height of the current block, m is equal to the average of the reconstructed samples of one row above the current block and one column on the left side of the current block, see FIG. 1A for detail;
(ii) When the width of the current block is greater than the height of the current block, m is equal to the mean of the reconstructed samples in one row above the current block, see FIG. 1B for detail; and
(iii) When the height of the current block is greater than the width of the current block, m is equal to the mean of reconstructed samples in one column on the left side of the current block, see FIG. 1C for details.

In the implementation, the calculation method here can also be summarized as shown in Table 1.

TABLE 1

| | |
|---|---|
| Sum = 0, numSamples = 0 | |
| when(blockWidth >= blockHeight) | |
| { | |
| for(int i = 0; i < blockWidth; i++) | |
| { | |
| Sum += aboveBuffer[i] | Accumulate above reconstructed |
| | values |
| } | |
| numSamples += blockWidth | Calculate the number of samples |
| } | |
| when(blockHeight >= blockWidth) | |
| { | |
| for(int i = 0; i < blockHeight; i++) | |
| { | |
| Sum += leftBuffer[i] | Accumulate left side |
| | reconstructed values |
| } | |
| numSamples += blockHeight | Calculate the number of samples |
| } | |
| Shift = log2(numSamples) | Calculate the corresponding shift |
| | value of the number of samples |
| Offset = 1 << (Shift − 1) | Calculate the offset value used for |
| | rounding when shift |
| m = (Sum + Offset) >> Shift | Calculated mean m |

### (2) Obtaining Interpolation Filtering Coefficients.

In one possible embodiment, three types of 15-tap interpolation filters and three types of reconstructed regions are defined here.

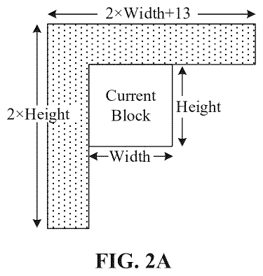

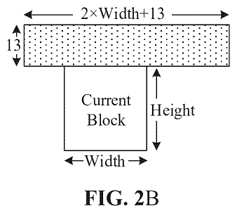

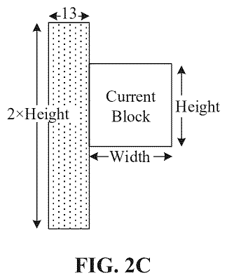

FIG. 2A shows a schematic diagram of a positional relationship between a current block and a reconstructed region. As shown in FIG. 2A, the reconstructed region may include a top neighboring region neighboring to the top side of the current block and a left neighboring region neighboring to the left side of the current block. The top neighboring region has a length of 2×Width+13 and a Width of 13. The left neighboring region has a height of 2×Height+13 and a width of 13. FIG. 2B shows another schematic diagram of the positional relationship between the current block and the reconstructed region. As shown in FIG. 2B, the reconstructed region may include a top neighboring region neighboring to the top side of the current block. The top neighboring region has a length of 2×Width+13 and a Width of 13. FIG. 2C shows yet another schematic diagram of the positional relationship between the current block and the reconstructed region. As shown in FIG. 2C, the reconstructed region may include a left neighboring region neighboring to the left side of the current block. The left neighboring region has a height of 2×Height+13 and a width of 13. In FIGS. 2A, 2B, and 2C, Height and Width represent the Height and Width of the current block, respectively. It should be noted that reconstructed samples of 13 rows and/or 13 columns around the current block for the reconstructed regions in FIGS. 2A, 2B, and 2C may be used to obtain interpolation filtering coefficients.

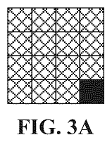

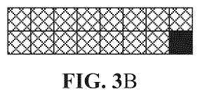

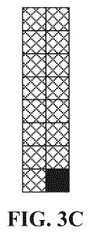

FIG. 3A shows a schematic diagram of a shape of an interpolation filter. As shown in FIG. 3A, the shape of the interpolation filter is a 4×4 square. FIG. 3B shows another schematic diagram of a shape of an interpolation filter. As shown in FIG. 3B, the shape of the interpolation filter is a 2×8 rectangle. FIG. 3C shows yet another schematic diagram of a shape of an interpolation filter. As shown in FIG. 3C, the shape of the interpolation filter is an 8×2 rectangle. In FIGS. 3A, 3B, and 3C, the grid-filled portion represents input positions of the interpolation filter, and the black-filled portion represents an output position of the interpolation filter.

Thus, 3×3 different filtering modes can be derived by different combinations of the three reconstructed regions and the three shapes of the interpolation filter (one filtering mode can be derived from a combination of each filter shape and each reconstructed region). An encoder decides a combination of one filter shape and a reconstructed region through the rate distortion cost, so that the encoder and the decoder first determine the coefficients of the interpolation filter based on the determined filter shape and reconstructed region when predicting the current block.

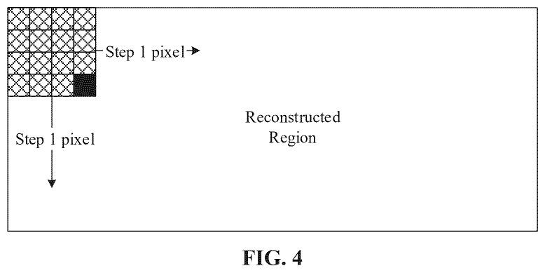

In one possible embodiment, if the inputs of the acquired interpolation filter is demeaned sample values (i.e., a reconstructed sample value minus the mean), the selected interpolation filter is slid over the selected region with horizontal and vertical sliding steps of a sample distance of 1 when obtaining the parameters. Specifically, as shown in FIG. 4, a structural diagram of a 4×4 interpolation filter obtaining inputs and output at possible positions of the interpolation filter on the selected reconstructed region is illustrated. An autocorrelation coefficient matrix and a cross-correlation coefficient vector are constructed from the acquired inputs and output. When there is a sample value which is not reconstructed in the selected reconstructed region, the sample values will not be counted in samples used for obtaining interpolation filter parameters.

In this case, for a constructed Wienerhoff equation, specifically a constructed autocorrelation coefficient matrix and a constructed cross-correlation coefficient vector, system of linear equations is as follows:

$$[ \begin{matrix}{\sum }_{‖ ℛ ‖} ( t [ r + {p}_{0} ] - m ) ( t [ r + {p}_{0} ] - m ) & ⋯ & {\sum }_{‖ ℛ ‖} ( t [ r + {p}_{N - 1} ] - m ) ( t [ r + {p}_{0} ] - m ) \\ ⋮ & ⋱ & ⋮ \\ {\sum }_{‖ ℛ ‖} ( t [ r + {p}_{0} ] - m ) ( t [ r + {p}_{N - 1} ] - m ) & ⋯ & {\sum }_{‖ ℛ ‖} ( t [ r + {p}_{N - 1} ] - m ) ( t [ r + {p}_{N - 1} ] - m )\end{matrix} ] [ \begin{matrix}{c}_{0} \\ ⋮ \\ {c}_{N - 1}\end{matrix} ] = [ \begin{matrix}{\sum }_{‖ ℛ ‖} ( t [ r ] - m ) ( t [ r + {p}_{0} ] - m ) \\ ⋮ \\ {\sum }_{‖ ℛ ‖} ( t [ r ] - m ) ( t [ r + {p}_{N - 1} ] - m )\end{matrix} ] \qquad ( 1 )$$

Where [symbol] represents a selected reconstructed region, t represents a reconstructed sample value, r represents a coordinate position in the reconstructed region, p₀ . . . p_{N-1} represent coordinate relationships relative to the position r, and the relative coordinates they refer to are the relative coordinate relationship between the input position and the output position of the interpolation filter. c₀ . . . c_{N-1} is coefficients of the interpolation filter to be solved (also called “filtering coefficients”), and m is a certain value subtracted from the inputs of the interpolation filter (at this time, the output needs to add the certain value).

### (3) Predict the Current Block.

In one possible embodiment, the prediction process predicts starting from the top left corner of the current block to the lower left corner of the current block in a certain order. The prediction formula is as follows:

$${pred}_{r} = Clip ( min , max , ( m + \sum ( ( {t}_{r + {p}_{n}} - m ) \times {c}_{n} ) ) ) \qquad ( 2 )$$

Where a and b in Clip (a, b, c) represent the output range that limits the prediction result. predᵣ is a prediction result of r position in the current block, min and max are the minimum value and the maximum value obtained above, and m is a certain value obtained above. tᵣ₊ₚ_{ₙ} represents the input of the interpolation filter, which needs to be subtracted by m, further multiplied with a corresponding filtering coefficient, and summed. When tᵣ₊ₚ_{ₙ} is located in the reconstructed region, the reconstructed value is used as the input of the interpolation filter, and when it is located in the current block, the obtained prediction value is used as the input of the interpolation filter.

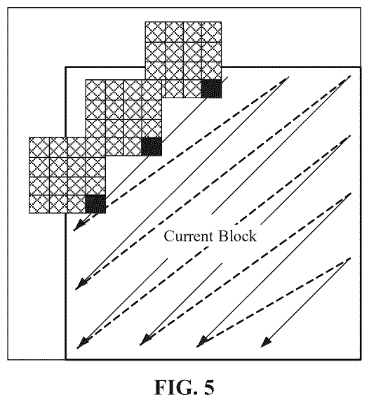

Exemplarily, as shown in FIG. 5, the interpolation filter is shown here to predict in a diagonal direction, where the grid-filled portion represents the input positions of the interpolation filter and the black-filled portion represents the output position of the interpolation filter. In addition, in the implementation, points to be predicted located on a same diagonal can be predicted in parallel.

### (4) Classification of Prediction Blocks and Selection of Transform Kernels.

After predicting the current block, a prediction block of the current block may be obtained, and the prediction block includes prediction values of one or more samples in the current block. For the prediction block, different transforms are suitable to be used for different angular modes, including primary transform MTS, NSPT, and secondary transform LFNST.

MTS includes some traditional transforms, such as DCT transform and DST transform. In NSPT and LFNST, a series of transform coefficients are obtained through a universal training set based on optimal transformation. The Difference between NSPT and LFNST is that NSPT is directly used to transform residual coefficients, while LFNST further transforms the transform coefficients after DCT2 transformation.

For traditional prediction modes (PLANAR mode, DC mode and angular mode), non-separable primary transformation (NSPT) or non-separable secondary transformation (LFNST), different traditional prediction modes, according to a mapping such as a table look-up method, can be mapped to different sets of transformation kernels for transformation.

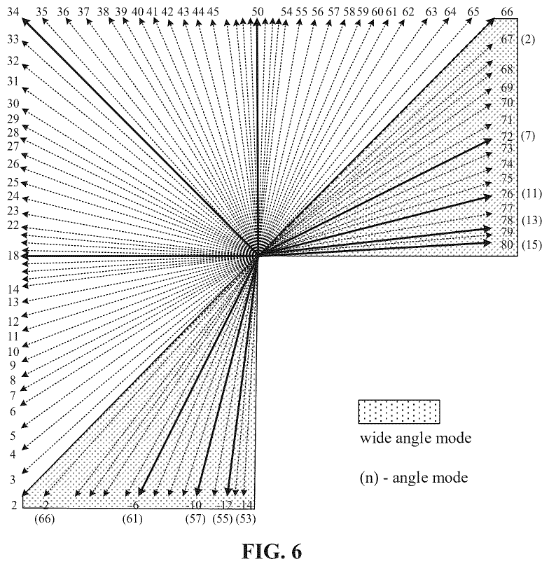

In the reference software ECM, as shown in FIG. 6, the traditional intra prediction mode may include:
(i) PLANAR mode: an index of the intra prediction mode is 0;
(ii) DC mode: an index of the intra prediction mode is 1;
(iii) Angular mode: an index of the intra prediction mode is 2 to 66.

It should also be noted that, as shown in FIG. 6, the intra prediction mode may include an angle mode of 2 to 66, and a wide angle mode of −1 to 14 and 67 to 80. A direction of an arrow in FIG. 6 is the direction of angle mode prediction existing in VVC, and indexes of the intra prediction modes used by them in encoding and decoding are 2 to 66. When the current block is a non-square block, some angle directions will be replaced with a wide angle mode (such as −1 to −14 and 67 to 80 in FIG. 6).

In the reference software ECM, NSPT and LFNST respectively divide the transformation kernels of traditional prediction modes into 35 groups, and each group has three selectable transformation kernels. Table 2 shows the correspondence between the traditional prediction mode and the transform kernel group.

TABLE 2

| | | | −14-−1, | | | | | | |
|---|---|---|---|---|---|---|---|---|---|
| | | | 67-80, 2 | | | | | | |
| | | | and 66 | 3 and 65 | 4 and 64 | 5 and 63 | 6 and 62 | 7 and 61 | 8 and 60 |
| Traditional | PLANAR | DC | angular | angular | angular | angular | angular | angular | angular |
| intra mode | mode | mode | directions | directions | directions | directions | directions | directions | directions |
| Group | 0 | 1 | 2 | 3 | 4 | 5 | 5 | 7 | 8 |
| 9 and 59 | 10 and 58 | 11 and 57 | 12 and 56 | 13 and 55 | 14 and 54 | 15 and 53 | 16 and 52 | 17 and 51 | 18 and 20 |
| angular | angular | angular | angular | angular | angular | angular | angular | angular | angular |
| directions | directions | directions | directions | directions | directions | directions | directions | directions | directions |
| 9 | 10 | 11 | 12 | 13 | 14 | 15 | 16 | 17 | 18 |
| 9 and 49 | 20 and 48 | 21 and 47 | 22 and 46 | 23 and 45 | 24 and 44 | 25 and 43 | 26 and 42 | 27 and 41 | 28 and 40 |
| angular | angular | angular | angular | angular | angular | angular | angular | angular | angular |
| directions | directions | directions | directions | directions | directions | directions | directions | directions | directions |
| 19 | 20 | 21 | 22 | 23 | 24 | 25 | 26 | 27 | 28 |
| 29 and 39 | 30 and 38 | 31 and 37 | 32 and 36 | 33 and 35 | 34 | | | | |
| angular | angular | angular | angular | angular | angular | | | | |
| directions | directions | directions | directions | directions | directions | | | | |
| 29 | 30 | 31 | 32 | 33 | 34 | | | | |

In one possible embodiment, a method of matching an interpolation filtering-based prediction block to a traditional prediction mode is proposed herein, and then the interpolation filtering-based prediction block based on is matched to different preset transform kernels for a primary transform (separable or non-separable) or secondary transform (separable or non-separable) through the matched traditional prediction mode. Specifically, the prediction block based on the interpolation filtering is matched to the PLANAR mode or the modes in the angular directions 2 to 66 by using the prediction values in the prediction block. Specifically, it may include the following steps.

In a first step, using the sliding 3×3 window, the gradient values Gₓ and G_{y} in the horizontal and vertical directions of each 3×3 window in the prediction block based on the interpolation filtering are calculated. Where Gₓ and G_{y} are obtained by dot-multiplying the horizontal gradient operator Mₓ and the vertical gradient operator M_{y} of 3×3 with the prediction values in the window position, respectively.

$${M}_{x} = [ \begin{matrix}- 1 & 0 & 1 \\ - 2 & 0 & 2 \\ - 1 & 0 & 1\end{matrix} ] \qquad ( 3 )$$

$${M}_{y} = [ \begin{matrix}- 1 & - 2 & - 1 \\ 0 & 0 & 0 \\ 1 & 2 & 1\end{matrix} ] \qquad ( 4 )$$

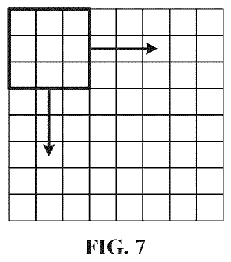

FIG. 7 is a schematic diagram of a 3×3 window sliding in a prediction block, which can be sliding in a horizontal direction and a vertical direction. Assuming that the interpolation filtering-based prediction block is a block with a width and a height of (w, h), then the sliding 3×3 window can be used to calculate Gₓ and G_{y} at (w−2)×(h−2) positions in the center of the prediction block.

In a second step, according to Gₓ and G_{y} at each position, the corresponding traditional angle direction O at each position is calculated according to the following formula, and the gradient amplitude value G of the corresponding angle at each position is calculated, as shown in detail:

$$G = \vert {G}_{x} \vert + \vert {G}_{y} \vert \qquad ( 5 )$$

$$O = atan ( \frac{{G}_{y}}{{G}_{x}} ) \qquad ( 6 )$$

In some embodiments, the calculation process of a tan( ) may be simplified, by looking up a table or some variation.

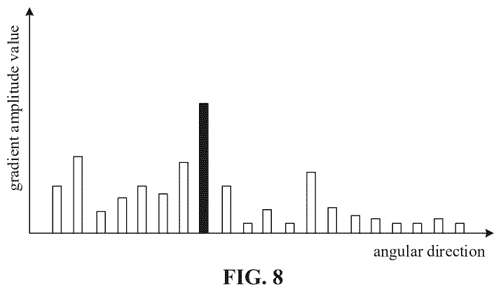

In a third step, the gradient amplitude values G at each position are respectively accumulated on the derived traditional angular mode thereof to obtain a histogram of the gradient amplitude values as shown in FIG. 8. Finally, the traditional angle mode with the largest accumulated gradient amplitude value is selected from the histogram as the prediction mode corresponding to the current block. In particular, when the gradient amplitude values derived for all traditional angular modes are zero, the current block will be matched to the traditional PLANAR mode as the corresponding prediction mode.

It should also be noted that in the embodiments of the present application, the traditional prediction mode derived by using the interpolation filtering prediction will be used for selecting the transform kernel group of NSPT and LFNST.

However, after the interpolation filtering-based intra prediction technique was proposed at the JVET conference, it is currently fed back that the ratio of codec performance and encoder complexity needs to be improved. On the latest ECM-8.0 reference software, the coding time complexity of the related technical solutions described herein is 108% to 109%.

Based on this, embodiments of the present application propose an encoding method. A target filtering mode for a current block is determined. A reference region for the current block is determined according to size parameter of the current block and a target filtering mode. Filtering coefficients for the current block are determined according to the reference region for the current block. Intra prediction is performing on the current block according to the filtering coefficients to determine prediction values of the current block.

Embodiments of the present application propose a decoding method. A bitstream is decoded to determine a target filtering mode for a current block. A reference region for the current block is determined according to size parameter of the current block and the target filtering mode. Filtering coefficients for the current block are determined according to the reference region for the current block. Intra prediction is performing on the current block according to the filtering coefficients to determine prediction values of the current block.

Thus, in the interpolation filtering-based intra prediction technique, the determination of the reference region for calculating the filtering coefficients is not only related to the target filtering mode, but also related to the size parameter of the current block. For example, a large reference region may be used when the size of the current block is large, and a small reference region may be used when the size of the current block is small. In this way, while ensuring the encoding and decoding performance, the computational complexity and the encoding time can be reduced, so that the ratio of the encoding and decoding performance and the encoding complexity can be improved, and at the same time, the intra prediction accuracy can be improved, thereby improving the encoding and decoding efficiency.

Hereinafter, the embodiments of the present application will be described in detail with reference to the accompanying drawings.

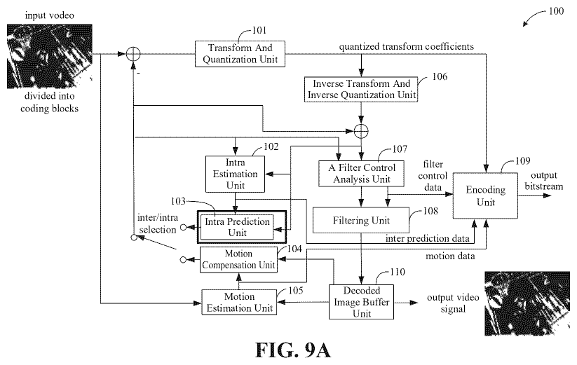

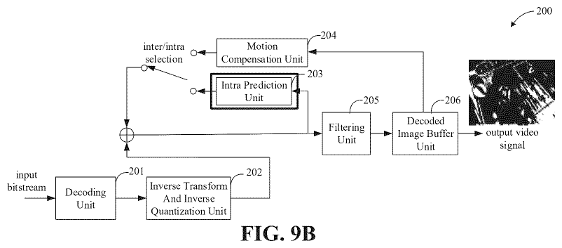

Referring to FIG. 9A, a schematic block diagram of a configuration of an encoder according to an embodiment of the present application is shown. As shown in FIG. 9A, the encoder (Specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, a decoded image buffer unit 110, and the like. The filtering unit 108 may implement de-block filtering and Sample Adaptive Offset (SAO) filtering. The encoding unit 109 may implement header information encoding and Context-based Adaptive Binary Arithmetic Coding (CABAC). For input original video signal, a video coding block can be obtained by dividing a Coding Tree Unit (CTU), and then residual sample information obtained after intra or inter prediction is transformed by the transform and quantization unit 101 to perform transformation on the video coding block, including transforming the residual information from the sample domain to the transform domain, and quantizing the obtained transform coefficients to further reduce the bit rate. The intra estimation unit 102 and the intra prediction unit 103 are configured to intra predict the video coding block. Specifically, the intra estimation unit 102 and the intra prediction unit 103 are configured to determine an intra prediction mode to be used to encode the video coding block. The motion compensation unit 104 and the motion estimation unit 105 are configured to perform inter prediction coding on the received video coded block with respect to one or more blocks in the one or more reference pictures to provide temporal prediction information. The motion estimation performed by the motion estimation unit 105 is a process of generating a motion vector that can be used to estimate the motion of the video coded block, and then motion compensation is performed by the motion compensation unit 104 based on the motion vector determined by the motion estimation unit 105. After determining the intra prediction mode, the intra prediction unit 103 is further configured to supply the selected intra prediction data to the encoding unit 109, and the motion estimation unit 105 also transmits the calculated motion vector data to the encoding unit 109. Further, the inverse transform and inverse quantization unit 106 is used for reconstruction of the video coding block, reconstructs a residual block in the sample domain. Block effect artifacts are removed from the reconstructed residual block by the filter control analysis unit 107 and the filtering unit 108. Then the reconstructed residual block is added to a prediction block in a picture in the decoded image buffer unit 110 to generate the reconstructed video coding block. The encoding unit 109 is configured to encode various encoding parameters and quantized transform coefficients, and in the CABAC-based encoding algorithm, the context content may be based on neighboring encoding blocks, and may be used to encode information indicating the determined intra prediction mode, to output a bitstream of the video signal. The decoded image buffer unit 110 is used to store the reconstructed video coding block for prediction reference. As the video image encoding progresses, new reconstructed video coding blocks are continuously generated, and these reconstructed video coding blocks are stored in the decoded image buffer unit 110.

Referring to FIG. 9B, a schematic block diagram of a configuration of a decoder according to an embodiment of the present application is shown. As shown in FIG. 9B, the decoder (specifically, a “video decoder”) 200 includes a decoding unit 201, an inverse transform and inverse quantization unit 202, an intra prediction unit 203, a motion compensation unit 204, a filtering unit 205, a decoded image buffer unit 206 and the like. The decoding unit 201 may implement header information decoding and CABAC decoding. The filtering unit 205 may implement de-block filtering and SAO filtering. After the input video signal is subjected to the encoding process of FIG. 9A, a bitstream of the video signal is output. The bitstream is input into the decoder 200 and first passes through a decoding unit 201 for obtaining the decoded transform coefficients. The transform coefficients are processed by the inverse transform and inverse quantization unit 202 to generate a residual block in the sample domain. The intra prediction unit 203 may be used to generate prediction data for a current video decoding block based on the determined intra prediction mode and data from a previously decoded block of the current frame or picture. The motion compensation unit 204 determines prediction information for a video decoding block by parsing the motion vector and other associated syntax elements, and uses the prediction information to generate a predictive block of the video decoding block being decoded. A decoded video block is formed by summing the residual block from the inverse transform and inverse quantization unit 202 with the corresponding predictive block generated by the intra prediction unit 203 or the motion compensation unit 204. The decoded video signal passes through the filtering unit 205 so as to remove block artifacts, and the video quality can be improved. The decoded video block is then stored in a decoded image buffer unit 206, which stores the reference picture for subsequent intra prediction or motion compensation, and also outputs the video signal, i.e. the recovered original video signal is obtained.

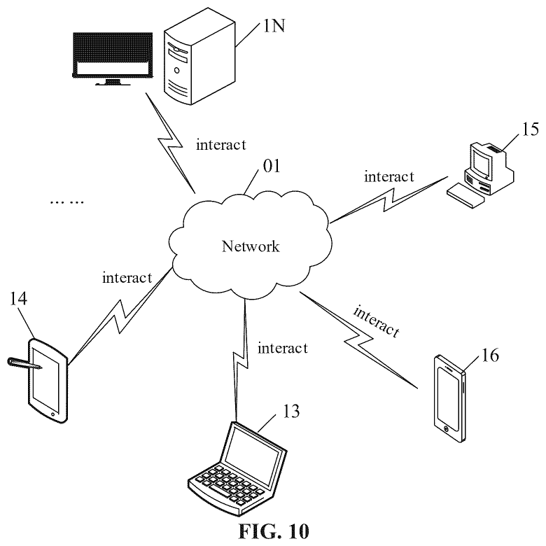

Further, an embodiment of the present application further provides a network architecture of a codec system including an encoder and a decoder. FIG. 10 shows a schematic diagram of a network architecture of a codec system according to an embodiment of the present application. As shown in FIG. 10, the network architecture includes one or more electronic devices 13-1N and a communication network 01. The electronic devices 13-1N may perform video interact through the communication network 01. In the process of implementation, the electronic device may be various types of devices having video encoding and decoding functions. For example, the electronic device may include a smartphone, a tablet computer, a personal computer, a personal digital assistant, a navigator, a digital phone, a video phone, a television, a sensing device, a server, and the like, which is not specifically limited in the embodiments of the present application. Here, the decoder or encoder described in the embodiments of the present application may be the above-described electronic device.

It should be noted that the method of the embodiments of the present application is mainly applied to the intra prediction unit 103 as shown in FIG. 9A and the intra prediction unit 203 as shown in FIG. 9B. That is, the embodiments of the present application may be applied to an encoder or a decoder, or may be applied to both the encoder and the decoder, which is not specifically limited in the embodiments of the present application.

It should also be noted that, when the method is applied to the intra prediction unit 103, a “current block” specifically refers to a coding block for which the intra prediction is to be performed. When the method is applied to the intra prediction unit 203, a “current block” specifically refers to a decoding block for which the intra prediction is to be performed.

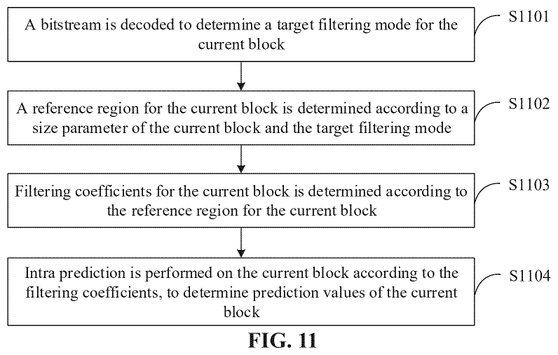

In an embodiment of the present application, reference is made to FIG. 11, which shows a schematic flowchart of a decoding method according to an embodiment of the present application. As shown in FIG. 11, the method may include operations S1101-S1104.

In S1101, a bitstream is decoded to determine a target filtering mode for the current block.

It should be noted that the decoding method according to the embodiment of the present application may be an intra prediction method, specifically, an improvement of an interpolation filtering-based intra prediction mode, so as to improve the ratio of performance and complexity.

It should also be noted that in the embodiment of the present application, the current block includes at least a first color component and a second color component. For the first color component of the current block, the block at this time may be simply referred to as a first color component block. Moreover, when the first color component is a luma component, the first color component block may also be referred to as a luma block. Similarly, for the second color component of the current block, the block at this time can be simply referred to as the second color component block. Moreover, when the second color component is a chroma component, the second color component block may also be referred to as a chroma block.

It should also be noted that, in the embodiment of the present application, the target filtering mode may refer to a mode in which the current block is intra-predicted using the target filter. Here, the target filter may refer to an interpolation filter.

It should also be noted that in the embodiment of the present application, the target filtering mode may be implemented using identification information of the first syntax element. That is, in some embodiments, the bitstream is decoded to determine a value of the identification information of the first syntax element. When the value of the identification information of the first syntax element is a first value, it is determined that the prediction mode for the current block is the target filtering mode. When the value of the identification information of the first syntax element is a second value, it is determined that the prediction mode for the current block is a non-target filtering mode.

In the embodiment of the present application, the first value is different from the second value, and the first value and the second value may be in the form of parameters or number. Specifically, the identification information of the first syntax element may be a parameter written in a profile, or may be a value of a flag, which is not specifically limited here.

Exemplarily, for the first value and the second value, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. However, in the embodiment of the present application, the first value is set to 1 and the second value is set to 0, which is not specifically limited herein.

It should also be noted that in the embodiment of the present application, the target filtering mode may include a type of a reference region for the current block and a shape of the target filter.

In some embodiments, the type of the reference region for the current block may include a first type, a second type, and a third type. The method may further include the following.

When the type of the reference region for the current block is the first type, it is determined that the reference region for the current block includes a top neighboring region and a left neighboring region.

When the type of the reference region for the current block is the second type, it is determined that the reference region for the current block includes a top neighboring region.

When the type of the reference region for the current block is the third type, it is determined that the reference region for the current block includes the left neighboring region.

In the embodiment of the present application, the reference region for the current block refers to a reconstructed region around the current block. Here, the top neighboring region may refer to a reconstructed region neighboring to the top side of the current block, and the left neighboring region may refer to a reconstructed region neighboring to the left side of the current block.

Exemplarily, the type of the reference region shown in FIG. 2A is the first type, the type of the reference region shown in FIG. 2B is the second type, and the type of the reference region shown in FIG. 2C is the third type.

In some embodiments, the shape of the target filter may include a first shape, a second shape, and a third shape. The first shape may be a 4×4 square, the second shape may be a 2×8 rectangle, and the third shape may be a 8×2 rectangle, which are not particularly limited herein.

Exemplarily, the target filter shown in FIG. 3A has the first shape, the target filter shown in FIG. 3B has the second shape, and the target filter shown in FIG. 3C has the third shape.

In this way, candidate filtering modes for the current block may be obtained by combining three types of the reference region and three shapes of the target filter. Exemplarily, a total of nine candidate filtering modes may be obtained by combining here, and the target filtering mode is one of the nine candidate filtering modes.

In S1102, a reference region for the current block is determined according to a size parameter of the current block and the target filtering mode.

It should be noted that, in the embodiments of the present application, after the target filtering mode for the current block is decoded, the reference region for the current block may be determined according to the size parameter of the current block. The size parameter of the current block may include a height and a width of the current block.

In some embodiments, the size parameter of the current block includes a height and width of the current block. The operation of determining the reference region for the current block based on the size parameter of the current block and the target filtering mode may include the following operations: a minimum parameter is determined from the height and the width of the current block; and the reference region for the current block is determined according to the minimum parameter and the target filtering mode.

In the embodiments of the present application, the size of the reference region for the current block is associated with the shape of the target filter and the minimum parameter. That is, when the size of the current block is large, then a large reference region can be used; when the size of the current block is small, then a small reference region may be used. Here, the number of rows and the number of columns of the reference region can be derived according to the size of the current block.

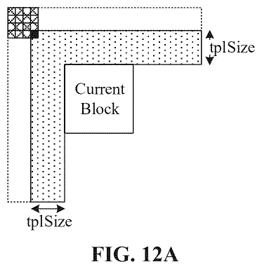

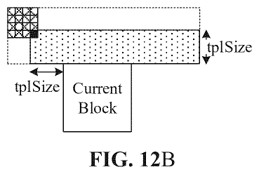

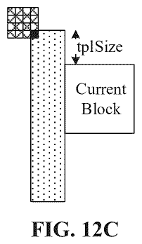

Exemplarily, FIG. 12A is a schematic diagram of a reference region for the current block, FIG. 12B is another schematic diagram of a reference region for the current block, and FIG. 12C is yet another schematic diagram of a reference region for the current block. As shown in FIGS. 12A, 12B and 12C, the region within the dashed line box is the reference region for the current block, which depends on the shape of the target filter used for the current block and the size of the variable tplSize. The size of the variable tplSize is equal to the smaller of the width and height of the current block. For example, for a current block of 4×8, the value of the variable tplSize is 4; for a current block of 16×16, the value of the variable tplSize is 16.

It is appreciated that in the embodiments of the present application, the enablement of the filtering mode may also be restricted according to the size parameter of the current block. Specifically, taking FIG. 12C as an example, for a current block having a width of 16 and a height of 4, the value of the variable tplSize is 4 at this time, which means that there are 4×16=64 samples to be predicted in the current block. There are tplSize×(tplSize+4×2)=48 samples used to obtain filtering coefficients. That is, when the left neighboring region is used to obtain the filtering coefficient, there are many samples to be predicted, but there are few samples in the reference region for obtaining the filtering coefficient, and the filtering coefficient obtained by using too few samples often leads to poor prediction effect.

In some embodiments, the method may further include the following operations.

When a multiple of the width of the current block and a first factor is smaller than the height of the current block, it is determined that the type of the reference region in the target prediction mode is any type other than the second type.

When a multiple of the height of the current block and the first factor is smaller than the width of the current block, it is determined that the type of the reference region in the target prediction mode is any type other than the third type.

In the embodiments of the present application, a value of the first factor may be a first preset constant. Exemplarily, the value of the first factor may be set to 2, but is not particularly limited herein.

In the embodiments of the present application, it is possible to determine whether certain filtering modes are disabled according to the ratio of the width to the height of the current block. Specifically, when the ratio of the width to the height of the current block is less than the reciprocal of the first factor, that is, the multiple of the width of the current block and the first factor is less than the height of the current block, the type of the reference region for the current block which may be disabled is the second type, that is, the calculation of the filtering coefficient using the top neighboring region of the current block may be disabled. At this time, the type of the reference region in the target prediction mode may only be the first type or the third type. When the ratio of the width to the height of the current block is larger than the first factor, that is, the multiple of the height of the current block and the first factor is smaller than the width of the current block, the type of the reference region for the current block which may be disabled is the third type, that is, the calculation of the filtering coefficient using the left neighboring region of the current block may be disabled, and at this time, the type of the reference region in the target prediction mode may only be the first type or the second type.

Thus, assuming that the shape of the target filter still has three types, the number of candidate filtering modes will be reduced accordingly since some reference region types are disabled. For example, when the type of the reference region for the current block which is disabled is the second type (i.e., the calculation of filtering coefficients using the top neighboring region of the current block is disabled), the number of candidate filtering modes is reduced to six. That is, since some interpolation filtering modes are restricted according to the ratio of width to height of the current block (referred to as “aspect ratio” for short), the number of candidate filtering modes allowed to be used is different under different aspect ratios. Therefore, when parsing the target filtering mode, decoding can be performed based on the context model.

In some embodiments, the operation of decoding the bitstream, to determine the target filtering mode for the current block may include operations that a context model for the current block is determined and the bitstream is decoded based on the context model, to determine the target filtering mode for the current block.

In the embodiments of the present application, the determination of the context model is associated with at least one of the following parameters:
a shape of the current block; or
a ratio of a width to a height of the current block.

That is, in the embodiments of the present application, the selection of the context model may be related to factors such as the shape and aspect ratio of the current block. Specifically, there are a plurality of context models at the decoding side, and which context model is used for decoding can be determined according to factors such as the shape and aspect ratio of the current block. Since, for the elongated and narrow current block, there are fewer interpolation filtering modes that can be selected, the length of the bins required for representing the selected interpolation filtering mode is short, however, the number of interpolation filtering modes allowed to be selected for the current blocks with other shapes is different, the length of bins required for representing a certain interpolation filtering mode is also long, which makes the probability of selecting an interpolation filtering modes in different shapes different. In this way, different context models need to be selected due to different probabilities. Here, indexes of different context models can be used to determine which context model is used.

It should also be noted that, in the embodiments of the present application, after the corresponding context model is selected, the value of the identification information of the first syntax element can be decoded according to the context model, to determine the target filtering mode for the current block. In this way, not only the prediction accuracy can be improved, but also the computational complexity can be reduced.

In S1103, filtering coefficients for the current block is determined according to the reference region for the current block.

It should be noted that in the embodiments of the present application, the filtering coefficients of the current block is mainly determined according to the reference region for the current block and the shape of the target filter. In some embodiments, the operation of determining the filtering coefficients for the current block according to the reference region for the current block may include the following operations.

Input values of the target filter and output values of the target filter corresponding to at least one reference sample in the reference region are determined according to the reference region for the current block and the shape of the target filter; an autocorrelation coefficient matrix is determined according to the input values of the target filter corresponding to at least one reference sample; a cross-correlation coefficient vector is determined according to the input values of the target filter and the output values of the target filter corresponding to the at least one reference sample; the coefficients for the target filter are determined according to the autocorrelation coefficient matrix and the cross-correlation coefficient vector; the coefficients for the target filter are determined as filtering coefficients for the current block.

Exemplarily, in the interpolation filtering-based intra prediction technique, the decoding side determines a shape of a filter and a type of a reference region corresponding to a current block by parsing related syntax elements, then traverses each position on the reference region to construct an autocorrelation coefficient matrix and a cross-correlation coefficient vector, and then obtains the filtering coefficients by solving the equation system.

Here, the autocorrelation coefficient matrix may be denoted by A, and the cross-correlation coefficient vector may be denoted by Y, as follows:

$$A = [ \begin{matrix}{\sum }_{‖ ℛ ‖} ( t [ r + {p}_{0} ] - m ) ( t [ r + {p}_{0} ] - m ) & ⋯ & {\sum }_{‖ ℛ ‖} ( t [ r + {p}_{N - 1} ] - m ) ( t [ r + {p}_{0} ] - m ) \\ ⋮ & ⋱ & ⋮ \\ {\sum }_{‖ ℛ ‖} ( t [ r + {p}_{0} ] - m ) ( t [ r + {p}_{N - 1} ] - m ) & ⋯ & {\sum }_{‖ ℛ ‖} ( t [ r + {p}_{N - 1} ] - m ) ( t [ r + {p}_{N - 1} ] - m )\end{matrix} ] \text{} \qquad ( 7 )$$

$$Y = [ \begin{matrix}{\sum }_{‖ ℛ ‖} ( t [ r ] - m ) ( t [ r + {p}_{0} ] - m ) \\ ⋮ \\ {\sum }_{‖ ℛ ‖} ( t [ r ] - m ) ( t [ r + {p}_{N - 1} ] - m )\end{matrix} ] \qquad ( 8 )$$

Further, a system of linear equations is constructed as follows,

$$A * [ \begin{matrix}{c}_{0} \\ ⋮ \\ {c}_{n - 1}\end{matrix} ] = Y \qquad ( 9 )$$

Here, [symbol] represents a selected reference region, t represents a reconstructed sample value, r represents a coordinate position in the reference region, p₀ . . . p_{N-1} represent the coordinate relationships with respect to the position r, and the relative coordinates they refer to are the relative coordinate relationships between the input position and the output position of the target filter. c₀ . . . c_{N-1} are filtering coefficients to be solved, and m is a certain value subtracted from the inputs of the target filter (a certain value added to the output at this time).

In S1104, intra prediction is performed on the current block according to the filtering coefficients, to determine prediction values of the current block.

It should be noted that, in the embodiments of the present application, the operation that the intra prediction is performed on the current block according to the filtering coefficients, to determine prediction values of the current block may include operations that: values of reference samples corresponding to a sample to be predicted in the current block are determined; and the prediction value of the sample to be predicted in the current block is determined according to the values of the reference samples corresponding to the sample to be predicted in the current block and the filtering coefficients.

In some embodiments, the operation that the values of the reference samples corresponding to the sample to be predicted in the current block are determined may include operations that based on the shape of the target filter, when a reference sample is located in the reference region for the current block, a reconstructed value at a position corresponding to the reference sample in the reference region is determined as a value of the reference sample; when a reference sample is located inside the current block, a prediction value at a position corresponding to the reference sample in the current block is determined as a value of the reference sample.

It should also be noted that, in the embodiments of the present application, for the inputs of the target filter, that is, the values of the reference samples corresponding to the sample to be predicted in the current block, when a position corresponding to a reference sample is within the reference region, the reconstructed value is used as the input of the target filter; alternatively, when a position corresponding to the reference sample is within the current block, the prediction value that has been predicted is used as an input to the target filter.

It should also be noted that in the embodiments of the present application, for the target filter, the interpolation filtering performs prediction according to the diagonal direction. Moreover, samples to be predicted located on the same diagonal can be predicted in parallel, as shown in FIG. 5 for details.

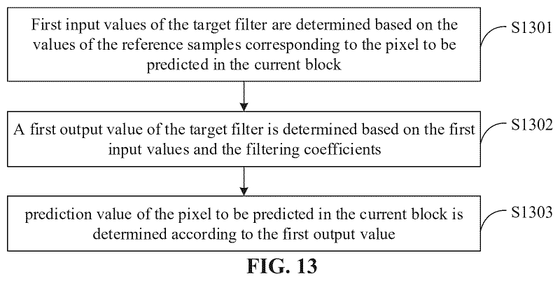

In some embodiments, for determining a prediction value of a sample to be predicted in the current block, referring to FIG. 13, the method may include S1301-S1303.

In S1301, first input values of the target filter are determined based on the values of the reference samples corresponding to the sample to be predicted in the current block.

It should be noted that, in the embodiments of the present application, for the inputs of the target filter, a certain value needs to be subtracted from the values of the reference samples as the inputs of the target filter, which are then multiplied by the filtering coefficients and summed. Therefore, in some embodiments, the operation that the first input values of the target filter are determined based on the values of the reference samples corresponding to the sample to be predicted in the current block may include operations that: a second factor is determined; and the second factor is subtracted from the values of the reference samples to obtain the first input values of the target filter.

In S1302, the first output value of the target filter is determined based on the first input values and the filtering coefficients.

Note that, in the embodiments of the present application, the operation that the first output value of the target filter is determined based on the first input values and the filtering coefficients may include operations that: a second output value of the target filter is determined based on the first input values and the filtering coefficients; and a first processing is performed on the second output value to determine the first output value of the target filter.

In some embodiments, the operation that the second output value of the target filter is determined based on the first input values and the filtering coefficients may include operations that: products of the first input values and the corresponding filtering coefficients are calculated; and the second output value of the target filter is set to be equal to a sum of n products; where n represents the number of input terms corresponding to the target filter, and n is a positive integer.

For example, it is assumed that values of reference samples corresponding to the sample r to be predicted in the current block can be represented by tᵣ₊ₚ_{ᵢ}, the second factor can be represented by m, and cᵢ represents the i-th filtering coefficient; i=0, 1, 2, . . . n−1. Then the second output value of the target filter is represented by Pₒᵤₜ₁, which is shown in the following formula:

$${P}_{out 1} = \sum ( ( {t}_{r + {p}_{i}} - m ) \times {c}_{i} ) \qquad ( 10 )$$

In a specific implementation, the operation that the first processing is performed on the second output value to determine the first output value of the target filter may include an operation that the second output value and the second factor are added to obtain the first output value of the target filter.

It should be noted that, in the embodiments of the present application, when a certain value is subtracted from the inputs of the target filter, the output of the target filter needs to be increased by the value. Therefore, the first output value of the target filter may be denoted by Pₒᵤₜ₂, where Pₒᵤₜ₂=m+Pₒᵤₜ₁=m+Σ((tᵣ₊ₚ_{ᵢ}−m)×cᵢ).

In some embodiments, the value of the second factor may be a second preset constant. Alternatively, in some embodiments, the method may further include operations that: reconstructed values of one or more reference samples in the reference region are determined; a mean of the reconstructed values of the one or more reference samples is calculated to obtain a first mean; and the value of the second factor is set to be equal to the first mean.

That is, the second factor may be obtained by calculating the mean of the reconstructed values in the reference region, or may be a preset constant, or may be a specific value, such as the reconstructed value on the top left of the current block, which is not specifically limited here. For example, when the second factor is the mean of the reference region, the inputs of the target filter need to subtract the mean, and accordingly, the output of the target filter needs to add the mean as the final prediction result.

In another specific implementation, the operation that the first processing is performed on the second output value to determine the first output value of the target filter may include operations that: a third output value of the target filter is determined; a fourth output value of the target filter is determined based on the second output value and the third output value; the fourth output value and the second factor are added to obtain the first output value of the target filter.

It should be noted that, in the embodiments of the present application, when calculating the output of the target filter, the number of input terms may include not only the number of linear terms, but also the number of nonlinear terms and/or the number of offset terms. Here, the third output value may be calculated based on the number of nonlinear terms and/or the number of the offset terms, and the second output value may be calculated based on the number of linear terms. In this case, the second output value of the target filter is obtained specifically as follows: the products of the first input values and the corresponding filtering coefficients may be calculated; the second output value of the target filter is set to be equal to a sum of n products; where n represents the number of first-type input terms corresponding to the target filter, and n is a positive integer.

In a specific implementation, the third output value is calculated based on the number of non-linear terms. In some embodiments, the operation that the third output value of the target filter is determined may include operations that: the number of first-type input terms corresponding to the target filter is determined based on a shape of the target filter; when the number of first-type input terms corresponding to the target filter is p, p+q filtering coefficients for the target filter are determined, where p and q are both positive integers; the third output value of the target filter is determined according to the q filtering coefficients in the p+q filtering coefficients and q second-type input terms.

In another specific implementation, the third output value is calculated based on the number of offset terms. In some embodiments, the operation that the third output value of the target filter is determined may include operations that: a number of first-type input terms corresponding to the target filter is determined based on the shape of the target filter; when the number of first-type input terms corresponding to the target filter is p, p+m filtering coefficients for the target filter are determined, where p and m are both positive integers; the third output value of the target filter is determined according to m filtering coefficients among the p+m filtering coefficients and m third-type input terms.

In yet another specific implementation, the third output value is calculated based on the number of non-linear terms and the number of offset terms. In some embodiments, the operation that the third output value of the target filter is determined may include operations that: a number of first-type input terms corresponding to the target filter is determined based on the shape of the target filter; when the number of first-type input terms corresponding to the target filter is p, p+k filtering coefficients for the target filter are determined, where p and k are both positive integers; the third output value of the target filter is determined according to i filtering coefficients in the p+k filtering coefficients and i second-type input terms and j filtering coefficients in the p+k filtering coefficients and j third-type input terms; where i and j are both positive integers, and k=i+j.

In the embodiments of the present application, there is a linear relationship between first-type input terms and the values of the reference samples, there is a non-linear relationship between second-type input terms and the values of the reference samples, and third-type input terms are preset offset information. That is, the number of first-type input terms is the number of linear terms, the number of second-type input terms is the number of nonlinear terms, and the number of third-type input terms is the number of offset terms.

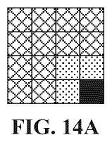

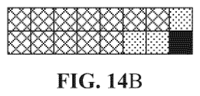

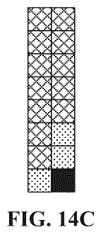

Exemplarily, it is assumed that the linear terms of the 15 taps of the target filter are represented as in FIGS. 3A, 3B, 3C. Where the black filled position represents the current position to be predicted. On this basis, nonlinear terms of three taps can also be added. The reconstructed sample positions used for the nonlinear terms are shown in FIGS. 14A, 14B, and 14C, specifically, three dot-filled positions.

Here, the interpolation inputs of 15 linear terms are pᵢ=tᵢ−m, the value of i is 0 to 14, which correspond to 14 grid-filled positions around the current position to be predicted, tᵢ is the reconstructed value or prediction value at the grid-filled position (depending on whether the input required for the current position to be predicted is located in the current block or in the reference region), m is a value subtracted, which can be the top left reconstructed value of the current block or the mean of the reference region, which is not specifically limited here.

Here, the interpolation inputs of the three nonlinear terms are pᵢ=((tᵢ−m)×(tᵢ−m)+midVal)>>bitDepth, i is the three dot-filled positions, pᵢ is a value of a nonlinear term, midVal and bitDepth are equal to 512 and 10 in the case of 10 bits. Thus, when the nonlinear term is added, for the current prediction position, the calculation formula of the first output value of the current position is:

$${P}_{out 2} = m + {\sum }_{i 0 = 0}^{14} ( ( {t}_{i 0} - m ) \times {c}_{i 0} ) + {\sum }_{i 1 = 0}^{2} ( {p}_{i 1} \times {c}_{i 1} ) \qquad ( 11 )$$

It should also be noted that in the acquisition of filtering coefficients, the corresponding nonlinear term values should also be added when constructing the autocorrelation coefficient matrix and the cross-correlation coefficient vector. In addition, when there is a bias term, the value of the bias term should be further added. Here, the setting is based on the actual situation, and is not particularly limited here.

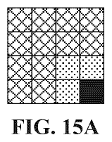

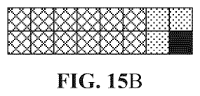

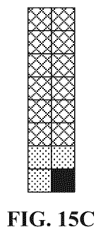

It can also be appreciated that, still taking the linear terms of 15 taps of the target filter shown in FIGS. 3A, 3B, and 3C as an example, on the basis of this, the non-linear terms of the three taps added here can also be as shown in FIGS. 15A, 15B, and 15C. The non-linear terms are specifically three dot-filled positions, and the black-filled positions represent the current position to be predicted. Compared with FIGS. 14A, 14B, and 14C, although three nonlinear terms are added in FIGS. 15A, 15B, and 15C, the calculation is simpler and the complexity is further reduced because the same nonlinear terms are used for each of different filter shapes.

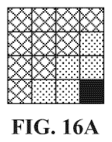

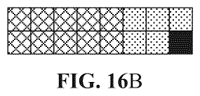

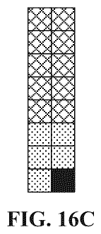

It should also be appreciated that for the number of nonlinear terms, in addition to using three nonlinear terms, more nonlinear terms can also be used in the embodiments of the present application. For example, five nonlinear terms are used in FIGS. 16A, 16B, and 16C, and the positions of the five nonlinear terms are specifically five positions filled with dots.

As described above, in the embodiments of the present application, the number of nonlinear terms should be a positive integer number, and the specific number is not limited, and different designs can be made according to the performance complexity requirements.

In S1303, the prediction value of the sample to be predicted in the current block is determined according to the first output value.

It should be noted that, in the embodiments of the present application, the operation that the prediction value of the samples to be predicted in the current block is determined according to the first output value may include an operation that a second process is performed on the first output value to obtain the prediction value of the sample to be predicted in the current block.

In a specific implementation, the second process may be to set the prediction value of the sample to be predicted in the current block equal to the first output value.

In another specific implementation, the second process may be to limit the first output value to a preset value range, or may also be referred to herein as a “clip operation”. A lower limit value of the preset value range is the minimum reconstructed value (min) in the reference region, and an upper limit value of the preset value range is the maximum reconstructed value (max) in the reference region.

That is, in the embodiments of the present application, the preset value range is between min and max. When a first output value is within the preset value range, the first output value may be used as a prediction value of the sample to be predicted in the current block. When a first output value is greater than max, max may be used as the prediction value of the sample to be predicted in the current block. When a first output value is less than min, min may be used as the prediction value of the sample to be predicted in the current block. Specifically, it can be expressed using the following formula:

$$pred = Clip ( min , max , {P}_{out 2} ) \qquad ( 12 )$$

In this way, after the correction operation is performed on the first output values, it can be guaranteed that the prediction values of all samples in the current block are between min and max.

Further, in some embodiments, the method may further include the following operations.

When intra prediction based on the filtering coefficient is used for a luma component of the current block, a derivation intra prediction mode for the luma component of the current block is determined;

When intra prediction in a direct mode is used for a chroma component of the current block, the direct mode is set to be the derivation intra prediction mode to determine the prediction values of the chroma component of the current block.

It should be noted that, in the embodiments of the present application, the derivation intra prediction mode may be a traditional PLANAR mode, a DC mode, an angle mode, or the like, and may be specifically determined according to the method of constructing the gradient histogram described above.

Here, for DM mode (i.e., “direct mode” or referred to as “derived mode”), which is an efficient intra chroma prediction mode applied in many standard to perform intra prediction, when the DM mode is selected and used for a chroma block, the mode selected for the luma block at the corresponding position is acquired and used for the chroma block to perform intra prediction.

Specifically, the interpolation filtering technique described in accordance with the foregoing embodiments only works for intra block prediction for luma, and a straightforward approach is to extend this mode to chroma, but this will lead to the need to derive filtering coefficients for chroma as well, which will bring high computational complexity. In the related art, there is no interpolation filtering-based intra prediction mode for chroma, and when the DM mode is selected for the chroma block, the DM mode is set to the PLANAR mode for prediction.

However, in the embodiments of the present application, for the luma block using the interpolation filtering mode, a traditional prediction mode can be derived by constructing a gradient histogram, and this traditional mode can be used when the DM mode is selected for the chroma mode and the interpolation filtering mode is selected for the luma block at the corresponding position.

Further, in some embodiments, the method may further include the following operations.

When the current block meets a preset condition, a reference block for the current block is determined;

A derivation intra prediction mode for the reference block is determined if the intra prediction based on filtering coefficients is used for the reference block; and

The derivation intra prediction mode is added to the intra prediction mode candidate list for the current block.

In the embodiments of the present application, the current block meeting the preset condition, includes at least one of the following:
The current block is an inter prediction block; or
The current block is an IBC block.

It should be noted that, in the embodiments of the present application, the IBC block and the inter block are not intra-coded blocks, so they do not have an intra prediction mode, and the initial reference blocks of the IBC block and the inter block are both intra prediction blocks. In the related art, when the acquisition of the reference block is completed by using the inter block and the IBC block, the intra prediction mode for the reference block is also simultaneously transferred to the current block, and these intra prediction modes are traditional intra prediction modes (PLANAR, DC, angle mode). These passed traditional intra prediction modes will be used if the surrounding blocks are IBC blocks or inter blocks when the intra prediction mode candidate list is constructed for the current block.

As described above, when the position referred to by the IBC block or the inter block is in the interpolation filtering mode, the traditional intra prediction mode corresponding to the interpolation filtering mode is used for transferring.

Further, in some embodiments, the method may further include operations that:
The bitstream is decoded to determine the residual values of the current block; and
A reconstructed value of the current block is determined according to the prediction values of the current block and the residual values of the current block.

In the embodiments of the present application, the operation that the bitstream is decoded to determine the residual values of the current block may include operations that: the bitstream is decoded to determine quantized coefficients of the current block; inverse quantization processing is performed on the quantized coefficients to obtain transform coefficients of the current block; and inverse transform processing is performed on the transform coefficients to obtain the residual values of the current block.

It should be noted that, in the embodiments of the present application, after the prediction of the current block is completed, the encoding side calculates residual values based on the original values and the prediction values, and the residual values are further transformed and quantized to obtain quantized coefficients, and then transmitted to the decoding side through the bitstream. In this way, the decoder can obtain the quantized coefficients of the current block through decoding, obtain the residual values of the current block through inverse quantization and inverse transform processing; and then obtain the reconstructed value of the current block according to the residual values of the current block and the prediction value of the current block.

Further, in some embodiments, the operation that inverse transform processing is performed on the transform coefficients to obtain the residual values of the current block may include operations that: when the current block uses a multi-transform selection mode and a target filtering mode is an interpolation filtering mode, a target transform kernel for the current block is determined; the inverse transform processing is performed on the transform coefficients according to the target transform kernel, to obtain the residual values of the current block.

In the embodiments of the present application, the determination of the target transformation kernel may be associated with at least one of the following parameters:
A target filtering mode for the current block;
The size parameter of the current block; or
The shape of the current block.

It should also be noted that, in the embodiments of the present application, a method for deriving the gradient histogram from the prediction result of the interpolation filtering prediction and matching to the traditional prediction mode, and further selecting the inseparable transformation kernel is provided. In other basic transform kernels except the inseparable transform kernel, the selection of transform kernel is the same as that of PLANAR mode. However, the characteristics of interpolation filtering mode are different from that of PLANAR mode, so the selection of basic transformation kernel should be more optimized.

In the reference software ECM, the basic transformation can be divided into a horizontal direction and a vertical direction, and the transformation modes allowed for each direction include the following seven types: {‘DCT2’, ‘DCT8’, ‘DST7’, ‘DCT5’, ‘DST4’, ‘DST1’, ‘IDTR’}.

Here, DCT2, DCT8, and DCT5 are subclasses of discrete cosine transform, DST7, DST4, and DST1 are subclasses of discrete sine transform, and IDTR is Identity transform, which means no transformation.

Further, in the reference software ECM, the most commonly used base conversion mode is DCT2 in both horizontal and vertical directions, herein referred to as DCT2-DCT2, which is used as a primary transformation before the indivisible quadratic transformation LFNST, and also as a transformation when the multi-transformation select MTS technique is turned off. When the MTS mode is selected, the transformation process will be a combination of the basic transformation in the horizontal direction and the vertical direction, rather than an inseparable transformation.

In some embodiments, the method may further include operations that: the bitstream is decoded, to determine information of non-zero coefficients for the current block; and one or more candidate transform kernels are determined according to the information of the non-zero coefficients for the current block.

In the embodiments of the present application, the number of one or more candidate transform kernels is less than or equal to 6. That is, in the reference software ECM, according to the parsed characteristics of the non-zero coefficients in the current block, the current block may have up to six transform kernels which is non-DCT2-DCT2 to select.

Thus, in the embodiments of the present application, for the prediction block in the interpolation filtering mode, the MTS base transform kernel for the residuals should be related to whether the interpolation filtering mode is selected for the current block. More specifically, the MTS base transform kernel for the residuals may be related to which interpolation filtering mode is selected and/or the size and shape of the current block.

In a specific implementation, the operation that the target transform kernel for the current block is determined may include operations that: the bitstream is decoded to determine an index value of a transform kernel for the current block; and according to the index value of the transform kernel, the target transform kernel for the current block is determined from one or more candidate transform kernels.

It should be noted that, for the candidate base transform kernel used in the current MTS mode of the ECM, the base transform kernel selectable by the MTS is related to whether the interpolation filtering prediction mode is selected for the current block. When the interpolation filtering prediction mode is used for the current block, the six optional MTS transform kernels are as follows (the transform kernel is: horizontal transform-vertical transform), as shown in Table 3.

TABLE 3

| | MTS index value | | | | | |
|---|---|---|---|---|---|---|
| | 0 | 1 | 2 | 3 | 4 | 5 |
| Transform | DST7- | DST7- | DST4- | DST4- | DST1- | DST7- |
| kernel | DST7 | DST4 | DST7 | DST4 | DST7 | DST1 |

Here, when the MTS is selected and the prediction mode for the current block is the interpolation prediction mode, the corresponding target transform kernel is selected from the six transform kernels based on the parsed index value of a MTS transform kernel to perform inverse transform.

In another specific implementation, the operation that the target transform kernel of the current block is determined may include operations that: the bitstream is decoded to determine an index value of a transform kernel for the current block; and a target transform kernel for the current block is determined from one or more candidate transform kernels according to the index value of the transform kernel and the size parameter of the current block.

It should also be noted that, for the candidate base transform kernel used in the current MTS mode of the ECM, the base transform kernel selectable by the MTS is related to whether the interpolation filtering mode is selected for the current block and the size and shape of the current block. Here, the size of the shape of the current block is: height×width. In one embodiment, it may be as shown in Table 4.

TABLE 4

| MTS index | 0 | 1 | 2 | 3 | 4 | 5 |
|---|---|---|---|---|---|---|
| 4 × 4 block | IDTR-IDTR | DST4-DST4 | IDTR-DST4 | DST4-IDTR | DST4-DCT8 | DCT8-DST4 |
| 4 × 8 block | IDTR-IDTR | DST4-DST4 | DST1-DST4 | DST7-DST4 | DCT8-DST4 | DST4-DCT5 |
| 4 × 16 block | DST7-DST4 | DST4-DST4 | DST1-DST4 | IDTR-IDTR | DCT5-DST4 | DST7-DCT5 |
| 4 × 32 block | DST4-DST4 | DST7-DST4 | DST4-DCT5 | DCT2-DCT5 | DST7-DCT5 | DCT2-IDTR |
| 8 × 4 block | IDTR-IDTR | DST4-DST4 | DST4-DST1 | DST4-DST7 | DST4-DCT8 | DCT5-DST4 |
| 8 × 8 block | DST7-DST7 | DST4-DST4 | DST7-DCT2 | DCT2-DST7 | DST7-DST1 | DST1-DST7 |
| 8 × 16 block | DST7-DST7 | DST1-DST7 | DST7-DST4 | DST1-DST4 | DCT5-DST7 | DST4-DST7 |
| 8 × 32 block | DST7-DST7 | DST4-DST7 | DCT2-DST7 | DST1-DST7 | DST7-DST4 | DCT5-DST7 |
| 16 × 4 block | DST4-DST7 | DST4-DST4 | DST4-DST1 | IDTR-IDTR | DST4-DCT5 | DCT5-DST7 |
| 16 × 8 block | DST7-DST7 | DST7-DST1 | DST4-DST7 | DST4-DST1 | DST7-DCT5 | DST7-DST4 |
| 16 × 16 block | DST7-DST7 | DST7-DST1 | DST1-DST7 | DCT5-DST7 | DST7-DCT5 | DST7-DST4 |
| 16 × 32 block | DST7-DST7 | DST4-DST7 | DCT2-DST7 | DST1-DST7 | DST7-DCT5 | DCT5-DST7 |
| 32 × 4 block | DST4-DST4 | DST4-DST7 | DCT5-DST4 | DCT5-DCT2 | DCT5-DST7 | IDTR-DCT2 |
| 32 × 8 block | DST7-DST7 | DST7-DST4 | DST7-DCT2 | DST7-DST1 | DST4-DST7 | DST7-DCT5 |
| 32 × 16 block | DST7-DST7 | DST7-DST4 | DST7-DCT2 | DST7-DST1 | DCT5-DST7 | DST7-DCT5 |
| 32 × 32 block | DST7-DST7 | DST4-DST7 | DST7-DST4 | DCT5-DST7 | DST7-DCT5 | DCT2-DST7 |

Here, when the MTS is selected and the prediction mode for the current block is the interpolation prediction mode, the corresponding target transform kernel is selected according to the parsed index value of the MTS transform kernel and the shape and size of the current block, to perform inverse transformation. In this embodiment, the interpolation filtering prediction mode may be applied to luma blocks of 4×4 to 32×32.

Further, the method of acquiring the candidate MTS transform kernel may include the following steps:
In step 1, an encoder including an interpolation filtering prediction mode is used to encode the image set or video set;
In step 2, for the residual values of the block for which the interpolation filtering mode is selected, a possible transformation kernel in the horizontal-vertical direction is selected class by class according to classes (e.g., the shape and size of the block, interpolation filtering mode, etc.). The selection criterion of the transform kernel may be the size of the SAD, the size of the SSE, or other metrics, such as transform coding gain, which are not specifically limited herein. The transform coding gain is defined as the arithmetically averaged transform coefficient variance divided by the geometrically averaged transform coefficient variance.

The embodiment provides a decoding method. The method includes operations that a bitstream is decoded to determine a target filtering mode for a current block; a reference region for the current block is determined according to a size parameter of the current block and the target filtering mode; the filtering coefficients for the current block is determined according to the reference region of the current block; and then intra prediction is performed on the current block according to the filtering coefficients to determine prediction values of the current block. In this way, in the interpolation filtering-based intra prediction technique, the determination of the reference region for calculating the filtering coefficients is related to not only the target filtering mode but also the size parameter of the current block. For example, a large reference region may be used when the size of the current block is large, and a small reference region may be used when the size of the current block is small. In this way, the computational complexity can be reduced and the encoding time can be reduced. At the same time, it can also improve the accuracy of intra prediction, thereby improving the coding and decoding performance.

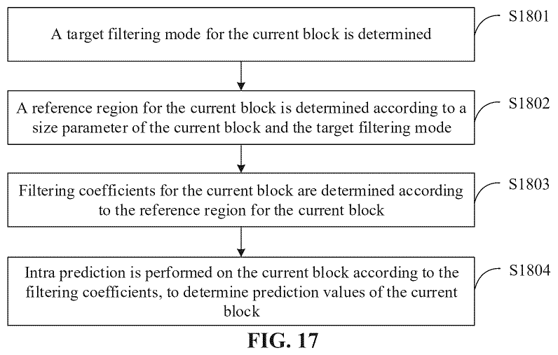

In another embodiment of the present application, reference is made to FIG. 17, which shows a schematic flowchart of an encoding method according to the embodiment of the present application. As shown in FIG. 17, the method may include operations S1801-S1804.

In S1801, a target filtering mode for the current block is determined.

It should be noted that the encoding method according to the embodiment of the present application may be an intra prediction method, specifically, an improvement of an interpolation filtering-based intra prediction mode, so as to improve performance and complexity cost performance.

It should also be noted that in the embodiment of the present application, the current block includes at least a first color component and a second color component. For the first color component of the current block, the block at this time may be simply referred to as a first color component block. Moreover, when the first color component is a luma component, the first color component block may also be referred to as a luma block. Similarly, for the second color component of the current block, the block at this time can be simply referred to as the second color component block. Moreover, when the second color component is a chroma component, the second color component block may also be referred to as a chroma block.

It should also be noted that, in the embodiment of the present application, the target filtering mode may refer to a mode in which the current block is intra-predicted using the target filter. Here, the target filter may refer to an interpolation filter.

In some embodiments, the operation that the target filtering mode for a current block is determined may include operations that:
one or more candidate filtering modes are determined; costs of one or more candidate filtering modes are calculated to determining cost results of the one or more candidate filtering modes; a minimum cost result is determined from the cost results of one or more candidate filtering modes, and a candidate filtering mode corresponding to the minimum cost result is determined as the target filtering mode of the current block.

In the embodiments of the present application, the number of one or more candidate filtering modes may be determined based on a number of types of the reference region of the current block and a number of shapes of a target filter.

In the embodiments of the present application, the cost results may be determined by using a distortion value method. Specifically, the cost result may be determined by using a manner of a rate distortion cost. However, the cost result may also be determined by using the size of the SAD, the size of the MSE, the size of the SSE, or other criteria for determining the cost, which are not specifically limited herein.

In some embodiments, a type of the reference region for the current block may include a first type, a second type, and a third type. The method may further includes the following operations:
When the type of the reference region for the current block is the first type, it is determined that the reference region for the current block includes a top neighboring region and a left neighboring region;
When the type of the reference region for the current block is the second type, it is determined that the reference region for the current block includes the top neighboring region;
When the type of the reference region of the current block is the third type, it is determined that the reference region for the current block includes the left neighboring region.

It should be noted that, in the embodiments of the present application, the reference region for the current block refers to a reconstructed region around the current block. Here, the top neighboring region may refer to a reconstructed region neighboring to a top side of the current block, and the left neighboring region may refer to a reconstructed region neighboring to a left side of the current block.

Exemplarily, the type of the reference region shown in FIG. 2A is the first type, the type of the reference region shown in FIG. 2B is the second type, and the type of the reference region shown in FIG. 2C is the third type.

In some embodiments, the shape of the target filter may include a first shape, a second shape, and a third shape. The first shape may be a 4×4 square, the second shape may be a 2×8 rectangle, and the third shape may be a 8×2 rectangle, which are not particularly limited herein.

Exemplarily, the target filter shown in FIG. 3A has the first shape, the target filter shown in FIG. 3B has the second shape, and the target filter shown in FIG. 3C has the third shape.

In this way, candidate filtering modes for the current block may be obtained by combining three types of the reference region and three shapes of the target filter. Exemplarily, a total of nine candidate filtering modes may be obtained by combining here, and the target filtering mode is one of the nine candidate filtering modes.

In S1802, a reference region for the current block is determined according to a size parameter of the current block and the target filtering mode.

It should be noted that, in the embodiments of the present application, after the target filtering mode for the current block is determined, the reference region for the current block may be determined according to the size parameter of the current block. The size parameter of the current block may include a height and a width of the current block.

In some embodiments, the size parameter of the current block includes a height and width of the current block. The operation that the reference region for the current block is determined based on the size parameter of the current block and the target filtering mode may include the following operations: a minimum parameter is determined from the height and the width of the current block; and the reference region for the current block is determined according to the minimum parameter and the target filtering mode.

In the embodiments of the present application, the size of the reference region for the current block is associated with the shape of the target filter and the minimum parameter. That is, when the size of the current block is large, then a large reference region can be used; When the size of the current block is small, then a small reference region may be used. Here, the number of rows and the number of columns of the reference region can be derived according to the size of the current block. Exemplarily, as shown in FIGS. 12A, 12B, and 12C, the region within the dashed box is a reference region for the current block, which depends on the shape of the target filter used for the current block and the size of the variable tplSize. The size of the variable tplSize is equal to the smaller of the width and height of the current block. For example, for the current block of 4×8, the value of the variable tplSize is 4; for the current block of 16×16, the value of the variable tplSize is 16.

It is appreciated that in the embodiments of the present application, the enablement of the filtering mode may also be restricted according to the size parameter of the current block. Specifically, taking FIG. 12C as an example, for a current block having a width of 16 and a height of 4, the value of the variable tplSize is 4 at this time, which means that there are 4×16=64 samples to be predicted in the current block. There are tplSize×(tplSize+4×2)=48 samples used to obtain filtering coefficients. That is, when the left neighboring region is used to obtain the filtering coefficient, there are many samples to be predicted, but there are few samples in the reference region for obtaining the filtering coefficient, and the filtering coefficient obtained by using too few samples often leads to poor prediction effect. Thus, in some embodiments, the method may further includes the following operations:

When a multiple of the width of the current block and a first factor is smaller than the height of the current block, the type of the reference region for the current block is disabled from being the second type, and determination of the number of the types of the reference region for the current block is determined based on types of the reference region other than the second type;

When a multiple of the height of the current block and the first factor is less than the width of the current block, the type of the reference region for the current block is disabled from being the third type, and determination of the number of the types of the reference region for the current block is determined based on other types of the reference region other than the third type.

In the embodiments of the present application, a value of the first factor may be a first preset constant. Exemplarily, the value of the first factor may be set to 2, but is not particularly limited herein.

In the embodiments of the present application, it is possible to determine whether or not certain filtering modes are disabled according to the ratio of the width to the height of the current block. Specifically, when the ratio of the width to the height of the current block is less than the reciprocal of the first factor, that is, the multiple of the width of the current block and the first factor is less than the height of the current block, the type of the reference region for the current block may be disabled from being the second type, that is, the calculation of the filtering coefficient using the top neighboring region of the current block may be disabled, and at this time, the type of the reference region in the target prediction mode may only be the first type or the third type. When the ratio of the width to the height of the current block is larger than the first factor, that is, the multiple of the height of the current block and the first factor is smaller than the width of the current block, the type of the reference region for the current block may be disabled from being the third type, that is, the calculation of the filtering coefficient using the left neighboring region of the current block may be disabled, and at this time, the type of the reference region in the target prediction mode may only be the first type or the second type.

In this way, assuming that the shapes of the target filter are still three, the number of candidate filtering modes will be reduced accordingly because some reference region types are disabled. For example, when the type of the reference region for the current block which is disabled is the second type (i.e., the calculation of filtering coefficients using the top neighboring region of the current block is disabled), the number of candidate filtering modes is reduced to six. That is, since some interpolation filtering modes are restricted according to the ratio of width to height of the current block (referred to as “aspect ratio” for short), the number of candidate filtering modes allowed to be used is different under different aspect ratios. Therefore, when encoding the target filtering mode, encoding can be based on the context model.

In some embodiments, after the target filtering mode for the current block is determined, the method may further include operations that: the target filtering mode for the current block is encoded, and resulting encoded bits are written into a bitstream.

In a specific implementation, the operation that the target filtering mode for the current block is encoded and the obtained encoded bits are written into the bitstream may include operations that: a context model for the current block is determined; the target filtering mode for the current block is encoded based on the context model, and the obtained coded bits are written into the bitstream.

In an embodiment of the present application, the determination of the context model is associated with at least one of the following parameters:
a shape of the current block; or
a ratio of a width to a height of the current block.

That is, in the embodiments of the present application, the selection of the context model may be related to factors such as the shape and aspect ratio of the current block. Specifically, there are a plurality of context models at the encoding side, and which context model is used for encoding can be determined according to factors such as the shape and aspect ratio of the current block. Since, for the elongated and narrow current block, there are fewer interpolation filtering modes that can be selected, the length of the bins required for representing the selected interpolation filtering mode is short, however, the number of interpolation filtering modes allowed to be selected for the current blocks with other shapes is different, the length of bins required for representing a certain interpolation filtering mode is also long, which makes the probability of selecting an interpolation filtering mode in different shapes different. In this way, different context models need to be selected due to different probabilities. Here, indexes of different context models can be used to determine which context model is used.

It should also be noted that, in the embodiments of the present application, after the corresponding context model is selected, the target prediction mode may be encoded according to the context model. Therefore, at the decoding side, the target prediction mode for the current block can be obtained by subsequently decoding the bitstream according to the context model selected according to the shape of the current block.

It should also be noted that, in the embodiments of the present application, the target filtering mode may include a type of the reference region for the current block and a shape of the target filter. Here, the target filtering mode may be written into the bitstream via the identification information of the first syntax element. That is, in some embodiments, a value of the identification information of the first syntax element is determined; the value of the identification information of the first syntax element is encoded based on the context model, and the obtained encoded bits are written into the bitstream.

In some embodiments, the operation that the value of the identification information of the first syntax element is determined may include operations that: when predictive encoding is performed for the current block using the target filtering mode, it is determined that the value of the identification information of the first syntax element is a first value; when predictive encoding is performed for the current block using a non-target filtering mode, the value of the identification information of the first syntax element is determined to be a second value.

In an embodiment of the present application, the first value is different from the second value, and the first value and the second value may be in a parameter form or a value form. Specifically, the identification information of the first syntax element may be a parameter written in a profile, or may be a value of a flag, which is not specifically limited here.

Exemplarily, for the first value and the second value, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. However, in the embodiments of the present application, the first value is set to 1 and the second value is set to 0, which is not specifically limited herein.

In this way, after the value of the identification information of the first syntax element is written into the bitstream, the decoding side can subsequently determine whether the prediction mode for the current block is the target prediction mode by parsing the value of the identification information of the first syntax element. For example, when the value of the identification information of the first syntax element obtained by parsing is 1, it may be determined that the prediction mode for the current block is the target prediction mode. In this way, not only the prediction accuracy can be improved, but also the computational complexity can be reduced.

In S1803, filtering coefficients for the current block are determined according to the reference region for the current block.

It should be noted that, in the embodiments of the present application, the reference region for the current block can be classified and divided to construct an autocorrelation coefficient matrix and a cross-correlation coefficient vector that do not include a repeated region, so that the encoding side can derive the filtering coefficients in each combination mode. In some embodiments, the method may further include the following operations.

A plurality of candidate sub-reference regions for the current block which do not overlap with each other are determined; an autocorrelation coefficient matrix and a cross-correlation coefficient vector of each of the plurality of candidate sub-reference regions are determined according to the plurality of candidate sub-reference regions and the shape of the target filter; and the autocorrelation coefficient matrix and the cross-correlation coefficient vector of each of the plurality of candidate sub-reference regions are stored in a preset buffer region.

In a specific embodiment, a first candidate sub-reference region is any one of the plurality of candidate sub-reference regions. Here, taking the first candidate sub-reference region as an example, the operation that the autocorrelation coefficient matrix and the cross-correlation coefficient vector of the first candidate sub-reference region are determined may specifically include operations that: input values of the target filter and output values of the target filter corresponding to one or more reference samples in the first candidate sub-reference region are determined according to the first candidate sub-reference region and the shape of the target filter; an autocorrelation coefficient matrix of the first candidate sub-reference region is determined according to the input values of the target filter corresponding to the one or more reference samples; a cross-correlation coefficient vector of the first candidate sub-reference region is determined according to the input values of the target filter and the output values of the target filter corresponding to the one or more reference samples. Thus, in this manner, the autocorrelation coefficient matrix and the cross-correlation coefficient vector of each of the plurality of candidate sub-reference regions may be determined.

It should also be noted that, in the embodiments of the present application, the encoding side needs to select from a total of nine combinations of three reference regions and three filter shapes. When a certain combination is selected, the identification information of the corresponding syntax element will be written into the bitstream. Then, when the decoder parses out that a certain combination is selected, it only needs to derive the filtering coefficients once. This makes the complexity of this technology much higher on the encoding side than on the decoding side.

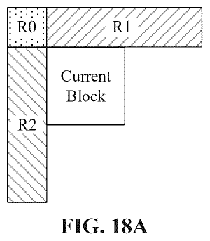

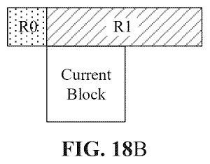

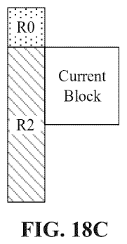

However, for the three reference regions as shown in FIGS. 2A, 2B, and 2C, they are all constituted by three parts, R0, R1, and R2, as shown in FIGS. 18A, 18B, and 18C. Here, as illustrated in FIG. 18A, the reference region for the current block may be divided into R0, R1, and R2. As illustrated in FIG. 18B, the reference region for the current block may be divided into R0 and R1. As shown in FIG. 18C, the reference region for the current block may be divided into R0 and R2.

Further, f₀, f₁, and f₂ represent three types of filter shapes, and Rₐₗₗ, Rₜₒₚ, and R_{left} represent three types of reference regions. The autocorrelation coefficient matrixes and cross-correlation coefficient vectors under the nine combinations can be written as follows:

$$\{ {A}_{{R}_{all} , {f}_{0}} , {Y}_{{R}_{all} , {f}_{0}} \} , \{ {A}_{{R}_{top} , {f}_{0}} , {Y}_{{R}_{top} , {f}_{0}} \} , \{ {A}_{{R}_{left} , {f}_{0}} , {Y}_{{R}_{left} , {f}_{0}} \} , \{ {A}_{{R}_{all} , {f}_{1}} , {Y}_{{R}_{all} , {f}_{1}} \} , \{ {A}_{{R}_{top} , {f}_{1}} , {Y}_{{R}_{top} , {f}_{1}} \} , \{ {A}_{{R}_{left} , {f}_{1}} , {Y}_{{R}_{left} , {f}_{1}} \} , \{ {A}_{{R}_{all} , {f}_{2}} , {Y}_{{R}_{all} , {f}_{2}} \} , \{ {A}_{{R}_{top} , {f}_{2}} , {Y}_{{R}_{top} , {f}_{2}} \} , \{ {A}_{{R}_{left} , {f}_{2}} , {Y}_{{R}_{left} , {f}_{2}} \} \qquad ( 13 )$$

where A represents the autocorrelation coefficient matrix and Y represents the cross-correlation coefficient vector. It should be noted that the construction of autocorrelation coefficient matrix and cross-correlation coefficient vector is similar to equations (7) and (8) at the decoding side, and will not be described in detail here.

Further, through observation, it can be found that since each of Rₐₗₗ, Rₜₒₚ, and R_{left} can be composed of R₀, R₁, R₂, the above nine combinations can be further decomposed into:

$$\{ {A}_{( {R}_{0} + {R}_{1} + {R}_{2} ) , {f}_{0}} , {Y}_{( {R}_{0} + {R}_{1} + {R}_{2} ) , {f}_{0}} \} , \{ {A}_{( {R}_{0} + {R}_{1} ) , {f}_{0}} , {Y}_{( {R}_{0} + {R}_{1} ) , {f}_{0}} \} , \{ {A}_{{R}_{left} , {f}_{0}} , {Y}_{{R}_{left} , {f}_{0}} \} , \{ {A}_{( {R}_{0} + {R}_{1} + {R}_{2} ) , {f}_{1}} , {Y}_{( {R}_{0} + {R}_{1} + {R}_{2} ) , {f}_{1}} \} , \{ {A}_{( {R}_{0} + {R}_{1} ) , {f}_{1}} , {Y}_{( {R}_{0} + {R}_{1} ) , {f}_{1}} \} , \{ {A}_{( {R}_{0} + {R}_{2} ) , {f}_{1}} , {Y}_{( {R}_{0} + {R}_{2} ) , {f}_{1}} \} , \{ {A}_{( {R}_{0} + {R}_{1} + {R}_{2} ) , {f}_{2}} , {Y}_{( {R}_{0} + {R}_{1} + {R}_{2} ) , {f}_{2}} \} , \{ {A}_{( {R}_{0} + {R}_{1} ) , {f}_{2}} , {Y}_{( {R}_{0} + {R}_{1} ) , {f}_{2}} \} , \{ {A}_{( {R}_{0} + {R}_{2} ) , {f}_{2}} , {Y}_{( {R}_{0} + {R}_{2} ) , {f}_{2}} \} \qquad ( 14 )$$

Further, by decomposing the addition of the matrix and the vector, it may be further expressed as:

$$\{ {A}_{{R}_{0} , {f}_{0}} + {A}_{{R}_{1} , {f}_{0}} + {A}_{{R}_{2} , {f}_{0}} , {Y}_{{R}_{0} , {f}_{0}} + {Y}_{{R}_{1} , {f}_{0}} + {Y}_{{R}_{2} , {f}_{0}} \} , \{ {A}_{{R}_{0} , {f}_{0}} + {A}_{{R}_{1} , {f}_{0}} , {Y}_{{R}_{0} , {f}_{0}} + {Y}_{{R}_{1} , {f}_{0}} \} , \{ {A}_{{R}_{0} , {f}_{0}} + {A}_{{R}_{2} , {f}_{0}} , {Y}_{{R}_{0} , {f}_{0}} + {Y}_{{R}_{2} , {f}_{0}} \} , \qquad ( 15 )$$

$$\{ {A}_{{R}_{0} , {f}_{1}} + {A}_{{R}_{1} , {f}_{1}} + {A}_{{R}_{2} , {f}_{1}} , {Y}_{{R}_{0} , {f}_{1}} + {Y}_{{R}_{1} , {f}_{1}} + {Y}_{{R}_{2} , {f}_{1}} \} , \{ {A}_{{R}_{0} , {f}_{1}} + {A}_{{R}_{1} , {f}_{1}} , {Y}_{{R}_{0} , {f}_{1}} + {Y}_{{R}_{1} , {f}_{1}} \} , \{ {A}_{{R}_{0} , {f}_{1}} + {A}_{{R}_{2} , {f}_{1}} , {Y}_{{R}_{0} , {f}_{1}} + {Y}_{{R}_{2} , {f}_{1}} \} , \qquad ( 16 )$$

$$\{ {A}_{{R}_{0} , {f}_{2}} + {A}_{{R}_{1} , {f}_{2}} + {A}_{{R}_{2} , {f}_{2}} , {Y}_{{R}_{0} , {f}_{2}} + {Y}_{{R}_{1} , {f}_{2}} + {Y}_{{R}_{2} , {f}_{2}} \} , \{ {A}_{{R}_{0} , {f}_{2}} + {A}_{{R}_{1} , {f}_{2}} , {Y}_{{R}_{0} , {f}_{2}} + {Y}_{{R}_{1} , {f}_{2}} \} , \{ {A}_{{R}_{0} , {f}_{2}} + {A}_{{R}_{2} , {f}_{2}} , {Y}_{{R}_{0} , {f}_{2}} + {Y}_{{R}_{2} , {f}_{2}} \} \qquad ( 17 )$$

Therefore, equations (15), (16) and (17) are simplified, and when constructing the autocorrelation coefficient matrix and the cross-correlation coefficient vector, only the following nine groups are needed to construct the matrices and vectors required for obtaining all filtering coefficients, as follows:

$$\{ {A}_{{R}_{0} , {f}_{0}} , {Y}_{{R}_{0} , {f}_{0}} \} , \{ {A}_{{R}_{1} , {f}_{0}} , {Y}_{{R}_{1} , {f}_{0}} \} , \{ {A}_{{R}_{2} , {f}_{0}} , {Y}_{{R}_{2} , {f}_{0}} \} , \{ {A}_{{R}_{0} , {f}_{1}} , {Y}_{{R}_{0} , {f}_{1}} \} , \{ {A}_{{R}_{1} , {f}_{1}} , {Y}_{{R}_{1} , {f}_{1}} \} , \{ {A}_{{R}_{2} , {f}_{1}} , {Y}_{{R}_{2} , {f}_{1}} \} , \{ {A}_{{R}_{0} , {f}_{2}} , {Y}_{{R}_{0} , {f}_{2}} \} , \{ {A}_{{R}_{1} , {f}_{2}} , {Y}_{{R}_{1} , {f}_{2}} \} , \{ {A}_{{R}_{2} , {f}_{2}} , {Y}_{{R}_{2} , {f}_{2}} \} \qquad ( 18 )$$

In this way, the encoding side can select an autocorrelation coefficient matrix and cross-correlation coefficient vector required for determining filtering coefficients for the current block from the nine groups of matrices and vectors. Therefore, in some embodiments, the operation that the filtering coefficients for the current block are determined according to the reference region for the current block may include operations that: the reference region for the current block is divided to determine at least one sub-reference region; an autocorrelation coefficient matrix and a cross-correlation coefficient vector of each of at least one sub-reference region are acquired from a preset buffer region; coefficients for the target filter are determined according to an autocorrelation coefficient matrix and a cross-correlation coefficient vector of each of the at least one sub-reference region; and the coefficients for the target filter are determined as filtering coefficients for the current block.

That is, in the embodiments of the present application, when the encoding side derives the filtering coefficients according to the current combination and when performing rate-distortion optimization, it is necessary to cache the autocorrelation coefficient matrix and the cross-correlation coefficient vector that have not been constructed when they are encountered, for being used for subsequent combinations. Therefore, the computational complexity at the encoding side can be reduced.

In S1804, intra prediction is performed on the current block according to the filtering coefficients, to determine prediction values of the current block.

It should be noted that, in the embodiments of the present application, the operation that intra prediction is performed on the samples in the current block based on filtering coefficients to determine prediction values of the samples in the current block may include operations that: values of reference samples corresponding to a sample to be predicted in the current block are determined; and a prediction value of the sample to be predicted in the current block is determined according to the values of the reference samples and the filtering coefficients corresponding to the sample to be predicted in the current block.

In some embodiments, the operation that values of the reference samples corresponding to the sample to be predicted in a current block are determined may include operations that based on the shape of the target filter, when the reference sample is located in the reference region for the current block, a reconstructed value at a position corresponding to the reference sample in the reference region is determined as a value the reference sample; when the reference sample is located inside the current block, the prediction value at the position corresponding to the reference sample in the current block is determined as the value of the reference sample.

It should also be noted that, in the embodiments of the present application, for the inputs of the target filter, that is, the values of the reference samples corresponding to the sample to be predicted in the current block, when the position corresponding to a reference sample is within the reference region, the reconstructed value is used as the input of the target filter; alternatively, when the position corresponding to the reference sample is within the current block, the prediction value that has been predicted is used as the input to the target filter.

It should also be noted that in the embodiments of the present application, for the target filter, the interpolation filtering performs prediction according to the diagonal direction. Moreover, samples to be predicted located on the same diagonal can be predicted in parallel, as shown in FIG. 5 for details.

In some embodiments, the operation that the prediction value of the sample to be predicted in the current block is determined according to the values of the reference samples and the filtering coefficients corresponding to the sample to be predicted in the current block may include operations that:

First input values of the target filter are determined based on the reference sample values corresponding to the sample to be predicted in the current block;

A first output value of the target filter based on the first input values and the filtering coefficients; and

The prediction value of the sample to be predicted in the current block is determined according to the first output value.

It should be noted that, in the embodiments of the present application, for the inputs of the target filter, a certain value needs to be subtracted from the values of the reference samples as the inputs of the target filter, which are then multiplied by the filtering coefficients and summed. Therefore, in some embodiments, the operation that the first input values of the target filter are determined based on the values of the reference samples corresponding to the sample to be predicted in the current block may include operations that: a second factor is determined; and the second factor is subtracted from the values of the reference samples to obtain the first input values of the target filter.

It should also be noted that in the embodiments of the present application, the operation that the first output value of the target filter is determined based on the first input values and the filtering coefficients may include operations that: a second output value of the target filter is determined based on the first input values and the filtering coefficients; and a first processing is performed on the second output value to determine the first output value of the target filter.

In some embodiments, the operation that the second output value of the target filter is determined based on the first input values and the filtering coefficients may include operations that: products of the first input values and the corresponding filtering coefficients are calculated; and the second output value of the target filter is set to be equal to a sum of n products; where n represents the number of input terms corresponding to the target filter, and n is a positive integer.

For example, it is assumed that values of reference samples corresponding to the sample r to be predicted in the current block can be represented by tᵣ₊ₚ_{ᵢ}, the second factor can be represented by m, and cᵢ represents the i-th filtering coefficient; i=0, 1, 2, . . . n−1. Then the second output value of the target filter is represented by Pₒᵤₜ₁, which is shown in the following formula:

$${P}_{out 1} = \sum ( ( {t}_{r + {p}_{i}} - m ) \times {c}_{i} ) \qquad ( 19 )$$

In a specific implementation, the operation that the first processing is performed on the second output value to determine the first output value of the target filter may include an operation that the second output value and the second factor are added to obtain the first output value of the target filter.

It should be noted that, in the embodiments of the present application, when a certain value is subtracted from the inputs of the target filter, the output of the target filter needs to be increased by the value. Therefore, the first output value of the target filter may be denoted by Pₒᵤₜ₂, where Pₒᵤₜ₂=m+Pₒᵤₜ₁=m+Σ(tᵣ₊ₚ_{ᵢ}−m)×cᵢ).

In some embodiments, the value of the second factor may be a second preset constant. Alternatively, in some embodiments, the method may further include operations that: reconstructed values of one or more reference samples in the reference region are determined; a mean of the reconstructed values of the one or more reference samples is calculated to obtain a first mean; and the value of the second factor is set to be equal to the first mean.

That is, the second factor may be obtained by calculating the mean of the reconstructed values in the reference region, or may be a preset constant, or may be a specific value, such as the reconstructed value on the top left of the current block, which is not specifically limited here. For example, when the second factor is the mean of the reference region, the inputs of the target filter need to subtract the mean, and accordingly, the output of the target filter needs to add the mean as the final prediction result.

In another specific implementation, the operation that the first processing is performed on the second output value to determine the first output value of the target filter may include operations that: a third output value of the target filter is determined; a fourth output value of the target filter is determined based on the second output value and the third output value; the fourth output value and the second factor are added to obtain the first output value of the target filter.

It should be noted that, in the embodiments of the present application, when calculating the output of the target filter, the number of input terms may include not only the number of linear terms, but also the number of nonlinear terms and/or the number of offset terms. Here, the third output value may be calculated based on the number of nonlinear terms and/or the number of the offset terms, and the second output value may be calculated based on the number of linear terms. In this case, the second output value of the target filter is obtained specifically as follows: the products of the first input values and the corresponding filtering coefficients may be calculated; the second output value of the target filter is set to be equal to a sum of n products; where n represents the number of first-type input terms corresponding to the target filter, and n is a positive integer.

In a specific implementation, the third output value is calculated based on the number of non-linear terms. In some embodiments, the operation that the third output value of the target filter is determined may include operations that: the number of first-type input terms corresponding to the target filter is determined based on a shape of the target filter; when the number of first-type input terms corresponding to the target filter is p, p+q filtering coefficients for the target filter are determined, where p and q are both positive integers; the third output value of the target filter is determined according to the q filtering coefficients in the p+q filtering coefficients and q second-type input terms.

In another specific implementation, the third output value is calculated based on the number of offset terms. In some embodiments, the operation that the third output value of the target filter is determined may include operations that: a number of first-type input terms corresponding to the target filter is determined based on the shape of the target filter; when the number of first-type input terms corresponding to the target filter is p, p+m filtering coefficients for the target filter are determined, where p and m are both positive integers; the third output value of the target filter is determined according to m filtering coefficients among the p+m filtering coefficients and m third-type input terms.

In yet another specific implementation, the third output value is calculated based on the number of non-linear terms and the number of offset terms. In some embodiments, the operation that the third output value of the target filter is determined may include operations that: a number of first-type input terms corresponding to the target filter is determined based on the shape of the target filter; when the number of first-type input terms corresponding to the target filter is p, p+k filtering coefficients for the target filter are determined, where p and k are both positive integers; the third output value of the target filter is determined according to i filtering coefficients in the p+k filtering coefficients and i second-type input terms and j filtering coefficients in the p+k filtering coefficients and j third-type input terms; where i and j are both positive integers, and k=i+j.

In the embodiments of the present application, there is a linear relationship between first-type input terms and the values of the reference samples, there is a non-linear relationship between second-type input terms and the values of the reference samples, and third-type input terms are preset offset information. That is, the number of first-type input terms is the number of linear terms, the number of second-type input terms is the number of nonlinear terms, and the number of third-type input terms is the number of offset terms.

For example, taking FIGS. 14A, 14B, and 14C as examples, it is assumed that the linear terms of 15 taps are grid-filled positions, the nonlinear terms of 3 taps are dot-filled positions, and the black-filled positions represent the current position to be predicted.

Here, the interpolation inputs of 15 linear terms are p, 11-m, the value of i is 0 to 14, which correspond to 14 grid-filled positions around the current position to be predicted, tᵢ is the reconstructed value or prediction value at the grid-filled position (depending on whether the input required for the current position to be predicted is located in the current block or in the reference region), m is a value subtracted, which can be the top left reconstructed value of the current block or the mean of the reference region, which is not specifically limited here.

Here, the interpolation inputs of the three nonlinear terms are pᵢ=((tᵢ−m)×(tᵢ−m)+midVal)>>bitDepth, i is the three dot-filled positions, p, is a value of a nonlinear term, midVal and bitDepth are equal to 512 and 10 in the case of 10 bits. Thus, when the nonlinear term is added, for the current prediction position, the calculation formula of the first output value of the current position is:

$${P}_{out 2} = m + {\sum }_{i 0 = 0}^{14} ( ( {t}_{i 0} - m ) \times {c}_{i 0} ) + {\sum }_{i 1 = 0}^{2} ( {p}_{i 1} \times {c}_{i 1} ) \qquad ( 20 )$$

It should also be noted that in the acquisition of filtering coefficients, the corresponding nonlinear term values should also be added when constructing the autocorrelation coefficient matrix and the cross-correlation coefficient vector. In addition, when there is a bias term, the value of the bias term should be further added. Here, the setting is based on the actual situation, and is not particularly limited here.

It is also understood that the nonlinear terms of 3 taps added here may also be as shown in FIGS. 15A, 15B, and 15C. Compared with FIGS. 14A, 14B, and 14C, although three nonlinear terms are added in FIGS. 15A, 15B, and 15C, the calculation is simpler and the complexity is further reduced because the same nonlinear terms are used for each of different filter shapes.

It can also be understood that for the number of nonlinear terms, in addition to using three nonlinear terms, more nonlinear terms can also be used in the embodiments of the present application, for example, five nonlinear terms are used in FIGS. 16A, 16B, and 16C, and the positions of the five nonlinear terms are specifically five positions filled with dots. Thus, in the embodiments of the present application, the number of nonlinear terms should be a positive integer, and the specific number is not limited, and different designs can be performed according to the performance complexity requirements.

It should also be noted that, in the embodiments of the present application, the operation that the prediction value of the samples to be predicted in the current block is determined according to the first output value may include an operation that a second process is performed on the first output value to obtain the prediction value of the sample to be predicted in the current block.

In a specific implementation, the second process may be to set the prediction value of the sample to be predicted in the current block to be equal to the first output value.

In another specific implementation, the second process may be to limit the first output value to a preset value range, or may also be referred to herein as a “clip operation”. A lower limit value of the preset value range is the minimum reconstructed value (min) in the reference region, and an upper limit value of the preset value range is the maximum reconstructed value (max) in the reference region.

That is, in the embodiments of the present application, the preset value range is between min and max. When a first output value is within the preset value range, the first output value may be used as a prediction value of the sample to be predicted in the current block. When a first output value is greater than max, max may be used as the prediction value of the sample to be predicted in the current block. When a first output value is less than min, min may be used as the prediction value of the sample to be predicted in the current block. Specifically, it can be expressed using the following formula:

$$pred = Clip ( min , max , {P}_{out 2} ) \qquad ( 21 )$$

In this way, after the correction operation is performed on the first output value, it can be guaranteed that the prediction values of all samples in the current block are between min and max.

Further, in some embodiments, the method may further include the following operations.

When intra prediction based on the filtering coefficient is used for a luma component of the current block, a derivation intra prediction mode for the luma component of the current block is determined;

When intra prediction in a direct mode is used for a chroma component of the current block, the direct mode is set to be the derivation intra prediction mode to determine the prediction values of the chroma component of the current block.

It should be noted that, in the embodiments of the present application, the derivation intra prediction mode may be a traditional PLANAR mode, a DC mode, an angle mode, or the like, and may be specifically determined according to the method of constructing the gradient histogram described above.

Here, for DM mode (i.e., “direct mode” or referred to as “derived mode”), which is an efficient intra chroma prediction mode applied in many standard to perform intra prediction, when the DM mode is selected and used for a chroma block, the mode selected for the luma block at the corresponding position is acquired and used for the chroma block to perform intra prediction.

Specifically, the interpolation filtering technique described in accordance with the foregoing embodiments only works for intra block prediction for luma, and a straightforward approach is to extend this mode to chroma, but this will lead to the need to derive filtering coefficients for chroma as well, which will bring high computational complexity. In the related art, there is no interpolation filtering-based intra prediction mode for chroma, and when the DM mode is selected for the chroma block, the DM mode is set to the PLANAR mode for prediction.

However, in the embodiments of the present application, for the luma block using the interpolation filtering mode, a traditional prediction mode can be derived by constructing a gradient histogram, and this traditional mode can be used when the DM mode is selected for the chroma mode and the interpolation filtering mode is selected for the luma block at the corresponding position.

Further, in some embodiments, the method may further include the following operations.

When the current block meets a preset condition, a reference block for the current block is determined;

A derivation intra prediction mode for the reference block is determined if the intra prediction based on filtering coefficients is used for the reference block; and

The derivation intra prediction mode is added to the intra prediction mode candidate list for the current block.

In the embodiments of the present application, the current block meeting the preset condition, includes at least one of the following:
The current block is an inter prediction block; or
The current block is an IBC block.

In the embodiments of the present application, the IBC block and the inter block are not intra-coded blocks, so they do not have an intra prediction mode, and the initial reference blocks of the IBC block and the inter block are both intra prediction blocks. In the related art, when the acquisition of the reference block is completed by using the inter block and the IBC block, the intra prediction mode for the reference block is also simultaneously transferred to the current block, and these intra prediction modes are traditional intra prediction modes (PLANAR, DC, angle mode). These passed traditional intra prediction modes will be used if the surrounding blocks are IBC blocks or inter blocks when the intra prediction mode candidate list is constructed for the current block. Thus, when the position referred to by the IBC block or the inter block is in the interpolation filtering mode, the traditional intra prediction mode corresponding to the interpolation filtering mode is used for transferring.

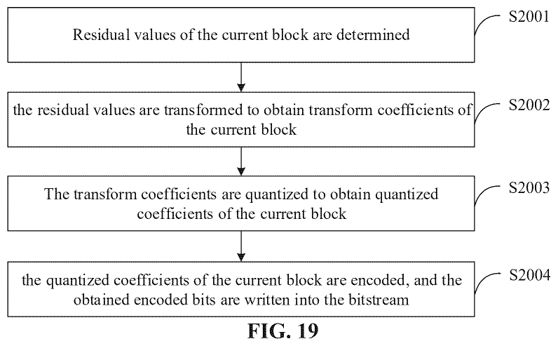

Further, in some embodiments, referring to FIG. 19, the method may further comprise operations S2001-S2004.

In S2001, residual values of the current block are determined.

In S2002, the residual values are transformed to obtain transform coefficients of the current block.

In S2003, the transform coefficients are quantized to obtain quantized coefficients of the current block.

In S2004, the quantized coefficients of the current block are encoded, and the obtained encoded bits are written into the bitstream.

It should be noted that, in the embodiments of the present application, the operation that the residual values of the current block are determined may include operations that: the original values of the current block are determined; the residual values of the current block is determined according to the original values of the current block and the prediction values of the current block. The residual values of the current block are then encoded, and the resulting encoded bits are written into the bitstream.

It should be noted that in the embodiments of the present application, the residual values of the current block can be determined by subtracting the original values of the current block and the prediction values of the current block. When encoding the residual values of the current block, it is necessary to transform and quantize the residual values first, write the obtained quantized coefficients into the bitstream, and then transmit it to the decoding side through the bitstream.

Further, for operation S2002, in some embodiments, the operation that the transform processing is performed on the residual values to obtain transform coefficients of the current block may include operations that: a target transform kernel for the current block is determined when the current block uses a multi-transform selection mode and the target filtering mode is an interpolation filtering mode; the transform processing is performed on the residual values according to the target transform kernel to obtain the transform coefficients of the current block.

In the embodiments of the present application, the determination of the target transformation kernel may be associated with at least one of the following parameters:
A target filtering mode for the current block;
A size parameter of the current block; or
The shape of the current block.

It should be noted that, in the embodiments of the present application, a method for deriving the gradient histogram from the prediction result of the interpolation filtering prediction and matching to the traditional prediction mode, and further selecting the inseparable transformation kernel is provided. In other basic transform kernels except the inseparable transform kernel, the selection of transform kernel is the same as that of PLANAR mode. However, the characteristics of interpolation filtering mode are different from that of PLANAR mode, so the selection of basic transformation kernel should be more optimized.

In the reference software ECM, the basic transformation can be divided into a horizontal direction and a vertical direction, and the transformation modes allowed for each direction include the following seven types: {′DCT2′, ‘DCT8’, ‘DST7’, ‘DCT5’, ‘DST4’, ‘DST1’, ‘IDTR’}.

Here, DCT2, DCT8, and DCT5 are subclasses of discrete cosine transform, DST7, DST4, and DST1 are subclasses of discrete sine transform, and IDTR is Identity transform, indicating no transformation.

Further, in the reference software ECM, the most commonly used base conversion mode is DCT2 in both horizontal and vertical directions, herein referred to as DCT2-DCT2, which is used as a primary transformation before the indivisible quadratic transformation LFNST, and also as a transformation when the multi-transformation select MTS technique is turned off. When the MTS mode is selected, the transformation process will be a combination of the basic transformation in the horizontal direction and the vertical direction, rather than an inseparable transformation.

In some embodiments, the method may further include operations that: information of non-zero coefficients for the current block is determined; and one or more candidate transform kernels are determined according to the information of the non-zero coefficients for the current block.

In the embodiments of the present application, the number of one or more candidate transform kernels is less than or equal to 6. That is, in the reference software ECM, according to the characteristics of the non-zero coefficients in the current block which is determined after transformation and quantization, the current block may have up to six transform kernels which is non-DCT2-DCT2 to select.

Thus, in the embodiments of the present application, for the prediction block in the interpolation filtering mode, the MTS base transform kernel for the residuals should be related to whether the interpolation filtering mode is selected for the current block. More specifically, the MTS base transform kernel for the residuals may be related to which interpolation filtering mode is selected and/or the size and shape of the current block.

In a specific implementation, the operation that the target transform kernel for a current block is determined may include operations that: one or more candidate transform kernels are determined; costs of the one or more candidate transform kernels are calculated to determine cost results of the one or more candidate transform kernels; a minimum cost result is determined from the cost results of one or more candidate transform kernels, and a candidate transform kernel corresponding to the minimum cost result is determined as a target transform kernel for the current block.

It should be noted that, in the embodiments of the present application, the cost result may be determined using a distortion value method. Specifically, the cost result may be determined using a manner of a rate distortion cost. However, the cost result may also be determined by using the size of the SAD, the size of the MSE, the size of the SSE, or other criteria for determining the cost, which are not specifically limited herein.

In some embodiments, the method may further include operations that: an index value of the transform kernel for the current block is determined, the index value of the transform kernel is used to indicate an index sequence number of the target transform kernel in the one or more candidate transform kernels; the index value of the transform kernel for the current block is encoded, and resulting encoded bits are written into the bitstream.

It should be noted that, in the embodiments of the present application, for candidates for the base transform kernel used in the current MTS mode of ECM, the base transform kernel selectable by the MTS is related to whether the interpolation filtering prediction mode is selected for the current block. When the interpolation filtering prediction mode is used for the current block, the six optional MTS transform kernels are as follows (the transform kernel is: horizontal transform-vertical transform), as shown in Table 3.

Here, when the MTS is selected and the prediction mode for the current block is the interpolation prediction mode, the index value of the MTS transform kernel may be determined and written to the bitstream, so that the decoding side can, according to the parsed MTS index value of the transform kernel, select a corresponding target transform kernel from the six transform kernels to perform inverse transform.

In other embodiments, the method may further include operations that: an index value of the transform kernel for the current block is determined, the index value of the transform kernel is used to indicate an index sequence number of a target transform kernel in one or more candidate transform kernels, and the one or more candidate transform kernels have an association relationship with a size parameter of the current block; the index value of the transform kernel for the current block is encoded, and obtained encoded bits are written into the bitstream.

It should also be noted that, in the embodiments of the present application, for the candidate base transform kernels used in the current MTS mode of the ECM, the base transform kernels selectable by the MTS is related to whether the interpolation filtering mode is selected for the current block and the size and shape of the current block. The details are shown in Table 4. Here, the shape and size of the current block is: height×width.

Here, when the MTS is selected and the prediction mode for the current block is the interpolation prediction mode, the index value of the MTS transform kernel may be determined according to the size parameter of the current block and written into the bitstream, so that the decoding side can select the corresponding target transform kernel according to the parsed index value of the MTS transform kernel and the shape and size of the current block, to perform inverse transform. In this embodiment, the interpolation filtering prediction mode may be applied to luma blocks of 4×4 to 32×32.

It should also be noted that the method for obtaining the candidate MTS transform kernel may include the following steps:
In step 1, an encoder including an interpolation filtering prediction mode is used to encode the image set or video set;
In step 2, for the residual values of the block for which the interpolation filtering mode is selected, a possible transformation kernel in the horizontal-vertical direction is selected class by class according to classes (e.g., the shape and size of the block, interpolation filtering mode, etc.). The selection criterion of the transform kernel may be the size of the SAD, the size of the SSE, or other metrics, such as transform coding gain, which are not specifically limited herein. The transform coding gain is defined as the arithmetically averaged transform coefficient variance divided by the geometrically averaged transform coefficient variance.

Further, an embodiment of the present application further provides a bitstream, which is generated by bit encoding according to information to be encoded. The information to be encoded includes at least one of the following:
target filtering mode for A current block, residual values of the current block, and an index value of a transform kernel for the current block.

It should be noted that, in the embodiments of the present application, when writing the bitstream, the target filtering mode for the current block may be written into the bitstream via a value of identification information of a first syntax element. In addition, the residual values of the current block may be transformed and quantized to obtain quantized coefficients and then the quantized coefficients are written into the bitstream. In order to facilitate the decoding side to quickly determine the used target transform kernel, the encoding side also needs to write the index value of the transform kernel for the current block into the bitstream. Therefore, the coding and decoding efficiency is improved.

This embodiment provides an encoding method. A target filtering mode for a current block is determined. A reference region for the current block is determined according to a size parameter of the current block and a target filtering mode. Then, according to the reference region for the current block, the filtering coefficients for the current block are determined. Then, intra prediction is performed on the current block according to the filtering coefficients to determine prediction values of the current block. In this way, in the interpolation filtering-based intra prediction technique, the determination of the reference region for calculating the filtering coefficients is related to not only the target filtering mode but also the size parameter of the current block. For example, a large reference region may be used when the size of the current block is large, and a small reference region may be used when the size of the current block is small. In this way, the computational complexity can be reduced and the encoding time can be reduced. At the same time, it can also improve the accuracy of intra prediction, thereby improving the coding and decoding performance.

In another embodiment of the present application, based on the encoding/decoding method described in the foregoing embodiment, the improvement of the intra prediction mode based on the interpolation filtering is described in detail below from several aspects.

### (1) A Reference Region for the Current Block.

In the embodiments of the present application, the reference region always uses a reconstructed region consisting of 13 rows and/or 13 columns of reconstructed sample values, which results in much higher computational complexity on small blocks than on large blocks. On the encoding side, the encoder needs to decide the division of blocks, and increasing the amount of calculation for small blocks is more likely to lead to an increase in encoding time. Based on this, the embodiments of the present application propose that a large reference region is used for a large block and a small reference region is used for a small block, and the number of rows and the number of columns of the reference region can be derived according to the size of the block. The details are described previously in FIGS. 12A, 12B, and 12C.

### (ii) Limiting the Enablement of the Interpolation Filtering Mode According to the Shape of the Block.

For a current block having a width of 16 and a height of 4, when the left reconstructed region is used to obtain the coefficients of the interpolation filter, there are many samples to be predicted, and there are few samples in the region used to obtain the parameters of the interpolation filter, as shown in FIG. 12C. Here, for a current block having a width of 16 and a height of 4, tplSize is 4, which means that there are a total of 4×16=64 samples to be predicted, and the samples used to obtain filtering coefficients have a total of tplSize×(tplSize+4×2)=48, and coefficients of the interpolation filter obtained by using too few samples often cause poor prediction effect.

In the embodiments of the present application, it is also proposed here that for the ratio of the width and height of the current block, when width×N<height, it is forbidden to use the top reconstructed region to derive the interpolation filtering coefficients, and when height×N<width, it is forbidden to use the left reconstructed region to derive the interpolation filtering coefficients. For example, N=2.

Thus, when encoding and decoding the interpolation filtering mode, since some interpolation filtering sub-modes are restricted according to the aspect ratio, the number of interpolation filtering sub-modes allowed to be used is different under different aspect ratios. Therefore, when the syntax element identifier of the interpolation filtering is parsed, the selection of the context model should be related to the shape and aspect ratio factors of the block. It should be noted that it is assumed that the three reference region types and the three filter shapes can form nine interpolation filtering modes, each of which can be regarded as an interpolation filtering sub-mode. In other words, the interpolation filtering mode may include nine interpolation filtering sub-modes.

### (3) Optimizing the Process of Obtaining the Autocorrelation Coefficient Matrix at the Encoding Side.

In the embodiments of the present application, an autocorrelation coefficient matrix and a cross-correlation coefficient vector without repetitive regions can be constructed by classifying and dividing the reference regions, which are used for the encoding side to derive the filtering coefficients for each combination.

As in the foregoing embodiments, in the Interpolation filtering prediction technique, the decoding side determines the shape of the interpolation filter and the type of the reference region selected for the current block by parsing the related syntax elements, traverses each position on the reference region to construct an autocorrelation coefficient matrix and a cross-correlation coefficient vector, and solves the equation system to obtain filtering coefficients.

Herein, the constructed autocorrelation coefficient matrix and cross-correlation coefficient vector, and the linear equation system are as follows:

$$[ \begin{matrix}{\sum }_{‖ ℛ ‖} ( t [ r + {p}_{0} ] - m ) ( t [ r + {p}_{0} ] - m ) & ⋯ & {\sum }_{‖ ℛ ‖} ( t [ r + {p}_{N - 1} ] - m ) ( t [ r + {p}_{0} ] - m ) \\ ⋮ & ⋱ & ⋮ \\ {\sum }_{‖ ℛ ‖} ( t [ r + {p}_{0} ] - m ) ( t [ r + {p}_{N - 1} ] - m ) & ⋯ & {\sum }_{‖ ℛ ‖} ( t [ r + {p}_{N - 1} ] - m ) ( t [ r + {p}_{N - 1} ] - m )\end{matrix} ] [ \begin{matrix}{c}_{0} \\ ⋮ \\ {c}_{N - 1}\end{matrix} ] = [ \begin{matrix}{\sum }_{‖ ℛ ‖} ( t [ r ] - m ) ( t [ r + {p}_{0} ] - m ) \\ ⋮ \\ {\sum }_{‖ ℛ ‖} ( t [ r ] - m ) ( t [ r + {p}_{n - 1} ] - m )\end{matrix} ] \qquad ( 22 )$$

Where [symbol] represents a selected reconstructed region, t represents a reconstructed sample value, r represents a coordinate position in the reconstructed region, p₀ . . . p_{N-1} represent coordinate relationships relative to the position r, and the relative coordinates they refer to are the relative coordinate relationship between the input position and the output position of the interpolation filter. c₀ . . . c_{N-1} are filtering coefficients to be solved, and m is a certain value subtracted from the inputs of the interpolation filter (at this time, a certain value added to the output).

In the embodiments of the present application, the encoding side needs to select from a total of nine combinations formed by three reference regions and three filter shapes. When a certain combination is selected, a corresponding syntax element is written into the bitstream. If the decoding side parses out that a certain combination is selected, it only needs to derive the filtering coefficients once. This makes the technique much more complex on the encoding side than on the decoding side.

However, for the three types of reference regions in FIGS. 2A, 2B and 2C, they are all constituted by three parts, R0, R1 and R2, as in FIGS. 18A, 18B and 18C. Here, three types of filter shapes are denoted by f₀, f₁, and f₂, and three types of reference regions are denoted by Rₐₗₗ, Rₜₒₚ, and R_{left}. The autocorrelation coefficient matrix and cross-correlation coefficient vector under the nine combinations can be written as follows:

$$\{ {A}_{{R}_{all} , {f}_{0}} , {Y}_{{R}_{all} , {f}_{0}} \} , \{ {A}_{{R}_{top} , {f}_{0}} , {Y}_{{R}_{top} , {f}_{0}} \} , \{ {A}_{{R}_{left} , {f}_{0}} , {Y}_{{R}_{left} , {f}_{0}} \} , \{ {A}_{{R}_{all} , {f}_{1}} , {Y}_{{R}_{all} , {f}_{1}} \} , \{ {A}_{{R}_{top} , {f}_{1}} , {Y}_{{R}_{top} , {f}_{1}} \} , \{ {A}_{{R}_{left} , {f}_{1}} , {Y}_{{R}_{left} , {f}_{1}} \} , \{ {A}_{{R}_{all} , {f}_{2}} , {Y}_{{R}_{all} , {f}_{2}} \} , \{ {A}_{{R}_{top} , {f}_{2}} , {Y}_{{R}_{top} , {f}_{2}} \} , \{ {A}_{{R}_{left} , {f}_{2}} , {Y}_{{R}_{left} , {f}_{2}} \}$$

where A represents the autocorrelation coefficient matrix and Y represents the cross-correlation coefficient vector.

Further, through observation, it can be found that since each of Rₐₗₗ, Rₜₒₚ, and R_{left} can be composed of R₀, R₁, R₂, the above nine combinations can be further decomposed into:

$$\{ {A}_{( {R}_{0} + {R}_{1} + {R}_{2} ) , {f}_{0}} , {Y}_{( {R}_{0} + {R}_{1} + {R}_{2} ) , {f}_{0}} \} , \{ {A}_{( {R}_{0} + {R}_{1} ) , {f}_{0}} , {Y}_{( {R}_{0} + {R}_{1} ) , {f}_{0}} \} , \{ {A}_{{R}_{left} , {f}_{0}} , {Y}_{{R}_{left} , {f}_{0}} \} , \{ {A}_{( {R}_{0} + {R}_{1} + {R}_{2} ) , {f}_{1}} , {Y}_{( {R}_{0} + {R}_{1} + {R}_{2} ) , {f}_{1}} \} , \{ {A}_{( {R}_{0} + {R}_{1} ) , {f}_{1}} , {Y}_{( {R}_{0} + {R}_{1} ) , {f}_{1}} \} , \{ {A}_{( {R}_{0} + {R}_{2} ) , {f}_{1}} , {Y}_{( {R}_{0} + {R}_{2} ) , {f}_{1}} \} , \{ {A}_{( {R}_{0} + {R}_{1} + {R}_{2} ) , {f}_{2}} , {Y}_{( {R}_{0} + {R}_{1} + {R}_{2} ) , {f}_{2}} \} , \{ {A}_{( {R}_{0} + {R}_{1} ) , {f}_{2}} , {Y}_{( {R}_{0} + {R}_{1} ) , {f}_{2}} \} , \{ {A}_{( {R}_{0} + {R}_{2} ) , {f}_{2}} , {Y}_{( {R}_{0} + {R}_{2} ) , {f}_{2}} \}$$

By decomposing the addition of the matrix and the vector, it can be further expressed as:

$$\{ {A}_{{R}_{0} , {f}_{0}} + {A}_{{R}_{1} , {f}_{0}} + {A}_{{R}_{2} , {f}_{0}} , {Y}_{{R}_{0} , {f}_{0}} + {Y}_{{R}_{1} , {f}_{0}} + {Y}_{{R}_{2} , {f}_{0}} \} , \{ {A}_{{R}_{0} , {f}_{0}} + {A}_{{R}_{1} , {f}_{0}} , {Y}_{{R}_{0} , {f}_{0}} + {Y}_{{R}_{1} , {f}_{0}} \} , \{ {A}_{{R}_{0} , {f}_{0}} + {A}_{{R}_{2} , {f}_{0}} , {Y}_{{R}_{0} , {f}_{0}} + {Y}_{{R}_{2} , {f}_{0}} \} ;$$

$$\{ {A}_{{R}_{0} , {f}_{1}} + {A}_{{R}_{1} , {f}_{1}} + {A}_{{R}_{2} , {f}_{1}} , {Y}_{{R}_{0} , {f}_{1}} + {Y}_{{R}_{1} , {f}_{1}} + {Y}_{{R}_{2} , {f}_{1}} \} , \{ {A}_{{R}_{0} , {f}_{1}} + {A}_{{R}_{1} , {f}_{1}} , {Y}_{{R}_{0} , {f}_{1}} + {Y}_{{R}_{1} , {f}_{1}} \} , \{ {A}_{{R}_{0} , {f}_{1}} + {A}_{{R}_{2} , {f}_{1}} , {Y}_{{R}_{0} , {f}_{1}} + {Y}_{{R}_{2} , {f}_{1}} \} ;$$

$$\{ {A}_{{R}_{0} , {f}_{2}} + {A}_{{R}_{1} , {f}_{2}} + {A}_{{R}_{2} , {f}_{2}} , {Y}_{{R}_{0} , {f}_{2}} + {Y}_{{R}_{1} , {f}_{2}} + {Y}_{{R}_{2} , {f}_{2}} \} , \{ {A}_{{R}_{0} , {f}_{2}} + {A}_{{R}_{1} , {f}_{2}} , {Y}_{{R}_{0} , {f}_{2}} + {Y}_{{R}_{1} , {f}_{2}} \} , \{ {A}_{{R}_{0} , {f}_{2}} + {A}_{{R}_{2} , {f}_{2}} , {Y}_{{R}_{0} , {f}_{2}} + {Y}_{{R}_{2} , {f}_{2}} \}$$

Therefore, after simplification, when constructing the autocorrelation coefficient matrix and the cross-correlation coefficient vector, only the following nine groups are needed to construct all the matrices and vectors required for obtaining filtering coefficients, as follows:

$$\{ {A}_{{R}_{0} , {f}_{0}} , {Y}_{{R}_{0} , {f}_{0}} \} , \{ {A}_{{R}_{1} , {f}_{0}} , {Y}_{{R}_{1} , {f}_{0}} \} , \{ {A}_{{R}_{2} , {f}_{0}} , {Y}_{{R}_{2} , {f}_{0}} \} , \{ {A}_{{R}_{0} , {f}_{1}} , {Y}_{{R}_{0} , {f}_{1}} \} , \{ {A}_{{R}_{1} , {f}_{1}} , {Y}_{{R}_{1} , {f}_{1}} \} , \{ {A}_{{R}_{2} , {f}_{1}} , {Y}_{{R}_{2} , {f}_{1}} \} , \{ {A}_{{R}_{0} , {f}_{2}} , {Y}_{{R}_{0} , {f}_{2}} \} , \{ {A}_{{R}_{1} , {f}_{2}} , {Y}_{{R}_{1} , {f}_{2}} \} , \{ {A}_{{R}_{2} , {f}_{2}} , {Y}_{{R}_{2} , {f}_{2}} \}$$

Further, when the encoder derives filtering coefficients according to the current combination and when performing rate-distortion optimization, each time the encoder encounters an unconstructed autocorrelation coefficient matrix and an unconstructed cross-correlation coefficient vector, the encoder needs to buffer them for subsequent combinations, thereby reducing the computational complexity at the coding side.

### (4) Expansion of Chroma Intra Prediction Mode.

DM mode is an efficient intra chroma prediction mode applied in many standards for prediction. When the DM mode is selected for the chroma block, the mode selected by the luma block at the corresponding position will be acquired for the chroma block to perform intra prediction. The interpolation filtering technique described in the foregoing embodiment only acts on the prediction of the luminance intra block, and a direct method is to extend this mode to chroma, but this will lead to the need to derive filtering parameters for chroma, which will bring high computational complexity. In the related art, there is no Interpolation filtering prediction mode for chroma, and when the DM mode is selected for the chroma intra block, the DM mode is set to the PLANAR mode.

However, for the luma block using the interpolation filtering mode, a traditional prediction mode can be derived by constructing a gradient histogram, which can be used when the DM mode is selected as the chroma mode and the interpolation filtering mode is selected for the luma block at the corresponding position.

### (5) Traditional Prediction Mode Corresponding to Transferred Interpolation Filtering.

In IBC blocks and inter blocks, they are not intra-coded blocks, so they do not have intra prediction mode. However, the initial reference blocks for IBC blocks and inter blocks are intra prediction blocks. In the related art, when the acquisition of the reference block is completed through the inter block and the IBC block, the intra prediction mode for the reference block is also transferred to the current block. These intra prediction modes are traditional intra prediction modes (PLANAR, DC, angle mode). These transferred traditional intra prediction modes are used in a case that the surrounding blocks are IBC blocks or inter blocks when the intra prediction mode candidate list is constructed for the current block.

In one possible implementation, a technique that requires constructing an intra prediction candidate list may include the following:
(i) Intra-encoded blocks: these blocks may use a range of intra prediction techniques, such as Spatial geometric partitioning mode (SGPM), Template-based multiple reference line intra prediction (TMRL), Most probable mode (MPM), Template-based intra mode derivation (TIMD) techniques;
(ii) inter blocks, which may use a geometric partitioning mode (GPM);
(iii) blocks for Intra block copy (IBC), for these blocks, a prediction result can be obtained using the intra prediction mode and the copy-acquired block.

That is, in the embodiments of the present application, when the position referred to by the IBC block or the inter block is in the interpolation filtering mode, the traditional mode corresponding to the interpolation filtering mode is used for transferring.

### (6) Selection of a Basic Transform Kernel for an Interpolation Filtering Mode Prediction Block.

After the current block is predicted, the encoding side obtains residual values from prediction values and original values. The residual values will be further transformed and quantized. At the decoding side, the quantized coefficients parsed from the bitstream will be inverse-quantized and inverse-transformed to obtain reconstructed residual values, and the reconstructed residual values can be accumulated to the prediction values to obtain reconstructed values.

In the foregoing embodiments, a method of deriving a gradient histogram from a prediction result of an interpolation filtering prediction and matching it to a traditional prediction mode, and further selecting an inseparable transformation kernel is introduced. In other basic transform kernels other than the inseparable transform kernel, the selection of transform kernel is the same as that of PLANAR mode. Then, the characteristics of interpolation filtering mode are different from those of PLANAR mode, so the selection of basic transformation kernel should be more optimized.

In the reference software ECM, the basic transformation is divided into horizontal direction and vertical direction, and the allowable transformation modes for each direction include the following seven types: {′DCT2′, ‘DCT8’, ‘DST7’, ‘DCT5’, ‘DST4’, ‘DST1’, ‘IDTR’}. Here, DCT2, DCT8, and DCT5 are several subclasses of discrete cosine transform, DST7, DST4, and DST1 are several subclasses of discrete sine transform, and IDTR is Identity transform, which means no transformation.

In the reference software ECM, the most commonly used basic transformation mode is DCT2 in both horizontal and vertical directions, written as DCT2-DCT2, which is used as a primary transformation before the indivisible quadratic transformation LFNST, and also used as a transformation when the multi-transformation selection (MTS) technology is turned off. When the MTS mode is selected, the transformation process will be a combination of the basic transformation in the horizontal direction and the vertical direction, rather than an inseparable transformation. In the ECM, the current block may have up to six non-DCT2-DCT2 transform kernels to select according to the characteristics of non-zero coefficients in the parsed current block.

In the embodiments of the present application, for the prediction block for the interpolation filtering mode, the MTS base transform kernel of the residuals should be related to whether the interpolation filtering mode is selected in the current block, and more specifically, it may be related to which sub-mode of the interpolation filtering mode is selected and/or the size and shape of the current block.

Exemplarily, embodiments of the present application provide two implementations of basic change core candidates that can be used under the current MTS design of the ECM.

In one possible implementation, the base transform kernel which can be selected by the MTS is related to whether the interpolation filtering prediction mode is selected for the current block. When the interpolation filtering prediction mode is used for the current block, the six MTS transform kernels are as follows (the transform kernel is: horizontal transform-vertical transform), reference is made to Table 3 for details. When the MTS is selected and the prediction mode for the current block is the interpolation prediction mode, a corresponding target transform kernel is selected from the six transform kernels according to the parsed index value of the MTS transform kernel to perform inverse transform.

In another possible implementation, the base transform kernel which can be selected for the MTS is related to whether the interpolation filtering mode is selected for the current block and the size and shape of the current block, and the shape and size of the block is: height×width, reference is made to Table 4 for details. When the MTS is selected and the prediction mode for the current block is the interpolation prediction mode, a corresponding target transform kernel is selected according to the parsed index value of the MTS transform kernel and the shape and size of the block to perform inverse transform. In this embodiment, the interpolation filtering prediction mode may be applied to luma blocks of 4×4 to 32×32.

It should be noted that, the method for obtaining the candidate MTS transform kernel as described above may include the following steps:

In step 1, an encoder including an interpolation filtering prediction mode is used to encode an image set or a video set.

In step 2, for the residual values of the block for which the interpolation filtering mode is selected, a possible transformation kernel in the horizontal-vertical direction is selected class by class according to classes (e.g., the shape and size of the block, interpolation filtering mode, etc.). The selection criterion of the transform kernel may be the size of the SAD, the size of the SSE, or other metrics, such as transform coding gain, which are not specifically limited herein. The transform coding gain is defined as the arithmetically averaged transform coefficient variance divided by the geometrically averaged transform coefficient variance

### (7) Nonlinear Terms in Interpolation Filtering.

In the interpolation filtering described in the foregoing embodiment, the prediction of the interpolation filtering does not include a nonlinear term or a bias term. In order to improve the coding performance gain brought by the nonlinear term or the bias term, the nonlinear term or the bias term may be added to the interpolation filtering. Here, the 15 linear terms used in this implementation process are three cases as shown in FIG. 3A, FIG. 3B, and FIG. 3C, the linear terms of the 15 taps of the interpolation filter are grid-filled positions, and the black-filled position is a current position to be predicted. On this basis, nonlinear terms of three taps can also be added. The reconstructed sample positions used by the nonlinear terms are shown in FIGS. 14A, 14B, and 14C, specifically, three dot-filled positions.

Here, the interpolation inputs of 15 linear terms are pᵢ=tᵢ−m, the value of i is 0 to 14, which correspond to 14 grid-filled positions around the current position to be predicted, tᵢ is the reconstructed value or prediction value at the grid-filled position (depending on whether the input required for the current position to be predicted is located in the current block or in the reference region), m is a value subtracted, which can be the top left reconstructed value of the current block or the mean of the reference region, which is not specifically limited here.

Here, the interpolation inputs of the three nonlinear terms are pᵢ=((tᵢ−m)×(tᵢ−m)+midVal)>>bitDepth, i is the three dot-filled positions, p, is a value of a nonlinear term, midVal and bitDepth are equal to 512 and 10 in the case of 10 bits. Thus, when the nonlinear term is added, for the current prediction position, the calculation formula of the prediction value is:

$$Pred = Clip ( min , max , ( m + {\sum }_{i 0 = 0}^{14} ( ( {t}_{i 0} - m ) \times {c}_{i 0} ) + {\sum }_{i 1 = 0}^{2} ( {p}_{i 1} \times {c}_{i 1} ) ) ) \qquad ( 23 )$$

It should also be noted that in the acquisition of interpolation filtering coefficients, the corresponding nonlinear term values should also be added when constructing autocorrelation coefficient matrix and cross-correlation coefficient vector; And/or, when there is a bias term, the value of the bias term should also be further added when constructing the autocorrelation coefficient matrix and the cross-correlation coefficient vector.

In addition to the above-described embodiment, nonlinear terms of 3 taps added to the linear terms of the 15 taps of the target filter may also be as shown in FIGS. 15A, 15B, and 15C, the nonlinear terms may be specifically at three dot-filled positions, and the black-filled position represent the current position to be predicted. Compared with FIGS. 14A, 14B, and 14C, although three nonlinear terms are added in FIGS. 15A, 15B, and 15C, the same nonlinear terms are used for each of different filter shapes, the calculation is simpler, and the complexity is further reduced.

Further, for the number of nonlinear terms, in addition to using three nonlinear terms, more nonlinear terms may be used in the embodiments of the present application. For example, five nonlinear terms are used in FIGS. 16A, 16B, and 16C. As shown in FIGS. 16A, 16B, and 16C, on the basis of the linear terms of 15 taps of the interpolation filter, non-linear terms of 5 taps are added (specifically, positions filled with dots). That is, in the embodiments of the present application, the number of nonlinear terms should be a positive integer, and the specific number is not limited, and different designs can be made according to the performance complexity requirements.

In the embodiments of the present application, the specific implementation of the foregoing embodiments is described in detail through the above embodiments, from which it can be seen that according to the technical solution of the foregoing embodiment, while ensuring the encoding and decoding performance, the computational complexity and the encoding time can be reduced, so that a ratio of the encoding and decoding performance to the encoding complexity can be improved, and the intra prediction accuracy can be improved, thereby improving the encoding and decoding efficiency.

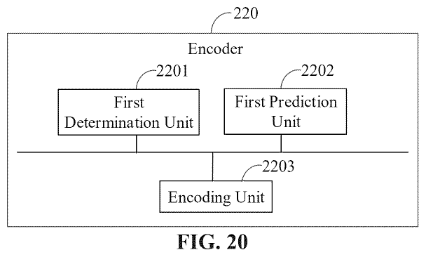

In still another embodiment of the present application, based on the same inventive concept as the above-described embodiments, reference is made to FIG. 20 which shows a schematic structural diagram of the configuration of an encoder according to an embodiment of the present application. As shown in FIG. 20, the encoder 220 may include a first determination unit 2201 and a first prediction unit 2202.

The first determination unit 2201 is configured to determine a target filtering mode for a current block; and determine a reference region for the current block according to a size parameter of the current block and the target filtering mode.

The first prediction unit 2202 is configured to determine filtering coefficients for the current block according to the reference region for the current block; and intra predict the current block according to the filtering coefficients to determine prediction values of the current block.

In some embodiments, the first determination unit 2201 is further configured to determine one or more candidate filtering modes; calculate costs of the one or more candidate filtering modes to determine cost results of the one or more candidate filtering modes; determine a minimum cost result from the cost results of the one or more candidate filtering modes, and determine the candidate filtering mode corresponding to the minimum cost result as the target filtering mode for the current block.

In some embodiments, the number of one or more candidate filtering modes is determined based on a number of types of the reference region for the current block and the number of shapes of a target filter.

In some embodiments, the target filtering mode includes a type of a reference region for the current block and a shape of a target filter.

In some embodiments, the first determination unit 2201 is further configured to: determine that the reference region for the current block includes a top neighboring region and a left neighboring region when the type of the reference region for the current block is a first type; determine that the reference region for the current block includes a top neighboring region when the type of the reference region for the current block is a second type; and determine that the reference region for the current block comprises the left neighboring region when the type of the reference region for the current block is a third type. The top neighboring region refers to a reconstructed region neighboring to a top side of the current block, and the left neighboring region refers to a reconstructed region neighboring to a left side of the current block.

In some embodiments, the size parameter of the current block includes a height and a width of the current block. The first determination unit 2201 is further configured to determine a minimum parameter from the height and the width of the current block; and determine the reference region for the current block according to the minimum parameter and the target filtering mode.

In some embodiments, a size of the reference region for the current block is associated with the shape of the target filter and the minimum parameter.

In some embodiments, the first determination unit 2201 is further configured to: when a multiple of the width of the current block and a first factor is less than the height of the current block, prohibit the type of the reference region for the current block from being the second type, and determine that a number of types for the reference region of the current block is determined based on other reference region types other than the second type; when a multiple of the height of the current block and the first factor is less than the width of the current block, prohibit the type of the reference region for the current block from being the third type, and determining that the number of types of the reference region for the current block is determined based on other reference region types other than the third type.

In some embodiments, the value of the first factor is a first preset constant.

In some embodiments, referring to FIG. 20, the encoder 220 may further include an encoding unit 2203 configured to encode the target filtering mode for the current block, and write obtained encoding bits into a bitstream.

In some embodiments, the first determination unit 2201 is further configured to determine a context model for the current block.

The encoding unit 2203 is further configured to encode the target filtering mode for the current block based on the context model, and write the obtained encoded bits into the bitstream.

In some embodiments, the determination of the context model is associated with at least one of the following parameters:
A shape of the current block; or
A ratio of width to height of the current block.

In some embodiments, the first determination unit 2201 is further configured to determine a plurality of candidate sub-reference regions for the current block which do not overlap with each other; determine autocorrelation coefficient matrices and cross-correlation coefficient vectors of each of the plurality of candidate sub-reference regions according to the plurality of candidate sub-reference regions and the shape of the target filter; and store the autocorrelation coefficient matrices and cross-correlation coefficient vectors of each of the plurality of candidate sub-reference regions into a preset buffer.

In some embodiments, the first determination unit 2201 is further configured to determine input values of the target filter and output values of the target filter corresponding to one or more reference samples in a first candidate sub-reference region, according to the first candidate sub-reference region and the shape of the target filter; determine an autocorrelation coefficient matrix of the first candidate sub-reference region according to the input values of the target filter corresponding to the one or more reference samples; and determine a cross-correlation coefficient vector of the first candidate sub-reference region according to the input values of the target filter and the output values of the target filter corresponding to the one or more reference samples, the first candidate sub-reference region is any one of the plurality of candidate sub-reference regions.

In some embodiments, the first determination unit 2201 is further configured to divide the reference region for the current block to determine at least one sub-reference region; obtain an autocorrelation coefficient matric and a cross-correlation coefficient vector of each of the at least one sub-reference region from the preset buffer; determine coefficients for the target filter according to the autocorrelation coefficient matric and the cross-correlation coefficient vector of each of the at least one sub-reference region; and determine the coefficients for the target filter as the filtering coefficients for the current block.

In some embodiments, the first determination unit 2201 is further configured to determine values of reference samples corresponding to a sample to be predicted in the current block;

The first prediction unit 2202 is further configured to determine a prediction value of the sample to be predicted in the current block according to the values of the reference samples corresponding to the sample to be predicted in the current block and the filtering coefficients.

In some embodiments, the first determination unit 2201 is further configured to: based on the shape of the target filter, when a reference sample is located in the reference region for the current block, determine a reconstructed value at a position corresponding to the reference sample in the reference region as a value of the reference sample; when a reference sample is located inside the current block, determine a prediction value at a position corresponding to the reference sample in the current block as the value of the reference sample.

In some embodiments, the first prediction unit 2202 is further configured to determine first input values of the target filter based on the values of the reference samples corresponding to the sample to be predicted in the current block; determine a first output value of the target filter based on the first input values and the filtering coefficients; and determine the prediction value of the sample to be predicted in the current block according to the first output value.

In some embodiments, the first determination unit 2201 is further configured to determine a second factor; and performing a subtraction operation on the values of the reference samples and the second factor to obtain the first input values of the target filter.

In some embodiments, the first determination unit 2201 is further configured to determine a second output value of the target filter based on the first input values and the filtering coefficients; and perform first processing on the second output value to determine the first output value of the target filter.

In some embodiments, the first determination unit 2201 is further configured to calculate products of the first input values and corresponding filtering coefficients; and set the second output value of the target filter equal to a sum of n said products, where n represents a number of input terms corresponding to the target filter, and n is a positive integer.

In some embodiments, the first determination unit 2201 is further configured to add the second output value and the second factor to obtain the first output value of the target filter.

In some embodiments, the first determination unit 2201 is further configured to determine a third output value of the target filter; determine a fourth output value of the target filter according to the second output value and the third output value; and add the fourth output value and the second factor to obtain the first output value of the target filter.

In some embodiments, the first determination unit 2201 is further configured to determine a number of first-type input terms corresponding to the target filter based on the shape of the target filter; when the number of first-type input terms corresponding to the target filter is p, determine p+q filtering coefficients for the target filter, where p and q are positive integers; and determine the third output value of the target filter according to q filtering coefficients among the p+q filtering coefficients and q second-type input terms.

In some embodiments, the first determination unit 2201 is further configured to determine a number of first-type input terms corresponding to the target filter based on the shape of the target filter; when the number of first-type input terms corresponding to the target filter is p, determine p+m filtering coefficients for the target filter, where p and m are positive integers; and determine the third output value of the target filter according to m filtering coefficients among the p+m filtering coefficients and m third-type input terms.

In some embodiments, the first determination unit 2201 is further configured to determine a number of first-type input terms corresponding to the target filter based on the shape of the target filter; when the number of first-type input terms corresponding to the target filter is p, determine p+k filtering coefficients for the target filter, where p and k are positive integers; determine the third output value of the target filter according to i filtering coefficients among the p+k filtering coefficients, i second-type input terms, j filtering coefficients among the p+k filtering coefficients and j third-type input terms, where i and j are positive integers, and k=i+j.

In some embodiments, the first-type input terms have a linear relationship with the values of the reference samples, the second-type input terms have a nonlinear relationship with the values of the reference samples, and the third-type input terms are preset bias information.

In some embodiments, a value of the second factor is a second preset constant.

In some embodiments, the first determination unit 2201 is further configured to determine reconstructed values of one or more reference samples in the reference region; calculate a mean of the reconstructed values of the one or more reference samples to obtain a first mean; and set a value of the second factor equal to the first mean.

In some embodiments, the first prediction unit 2202 is further configured to perform second processing on the first output value to obtain the prediction value of the sample to be predicted in the current block.

In some embodiments, the second processing is to set the prediction value of the sample to be predicted in the current block equal to the first output value.

In some embodiments, the second process is to limit the first output values within a preset value range, a lower limit value of the preset value range is a minimum reconstructed value in the reference region, and an upper limit value of the preset value range is a maximum reconstructed value in the reference region.

In some embodiments, the first determination unit 2201 is further configured to: when intra prediction based on the filtering coefficients is used for a luma component of the current block, determine a derivation intra prediction mode for the luma component of the current block; when intra prediction in a direct mode is used for a chroma component of the current block, set the direct mode as the derivation intra prediction mode to determine prediction values of the chroma component of the current block.

In some embodiments, the first determination unit 2201 is further configured to: when the current block meets a preset condition, determine the reference block for the current block; if intra prediction based on the filtering coefficients is used for the reference block, determine a derivation intra prediction mode of the reference block; and add the derivation intra prediction mode to an intra prediction mode candidate list for the current block.

In some embodiments, the current block meeting a preset condition at least includes one of the following:
the current block is an inter prediction block; or
the current block is IBC block.

In some embodiments, the first determination unit 2201 is further configured to determine original values of the current block; and determine residual values of the current block according to the original values of the current block and the prediction values of the current block.

The encoding unit 2203 is further configured to encode the residual values of the current block and write the obtained encoded bits into the bitstream.

In some embodiments, the coding unit 2203 is further configured to perform transform processing on the residual values to obtain transform coefficients of the current block; perform quantization processing on the transform coefficients to obtain quantized coefficients of the current block; and encode the quantized coefficients of the current block, and write the obtained encoding bits into the bitstream.

In some embodiments, the encoding unit 2203 is further configured to: when a multiple transform selection mode is used for the current block and a target filtering mode is an interpolation filtering mode, determine a target transform kernel for the current block; and perform the transform processing on the residual values according to the target transform kernel to obtain the transform coefficients of the current block.

In some embodiments, the determination of the target transformation kernel is associated with at least one of the following parameters:
the target filtering mode for the current block;
the size parameter of the current block; or
a shape of the current block.

In some embodiments, the first determination unit 2201 is further configured to determine one or more candidate transform kernels; calculate costs of the one or more candidate transform kernels to determine cost results of the one or more candidate transform kernels; and determine a minimum cost result from the cost results of the one or more candidate transform kernels, and determine a candidate transform kernel corresponding to the minimum cost result as the target transform kernel for the current block.

In some embodiments, the first determination unit 2201 is further configured to determine information of non-zero coefficients for the current block; and determine the one or more candidate transform kernels according to the information of the non-zero coefficients for the current block.

In some embodiments, the number of one or more candidate transform kernels is less than or equal to 6.

In some embodiments, the first determination unit 2201 is further configured to determine an index value of a transform kernel for the current block, herein the index value of the transform kernel is used to indicate an index number of the target transform kernel in the one or more candidate transform kernels.

The encoding unit 2203 is further configured to encode the index value of the transform kernel of the current block, and write obtained encoding bits into the bitstream.

In some embodiments, the first determination unit 2201 is further configured to determine an index value of a transform kernel for the current block, herein the index value of the transform kernel is used to indicate an index number of the target transform kernel in the one or more candidate transform kernels, and the one or more candidate transform kernels are associated with the size parameter of the current block.

The encoding unit 2203 is further configured to encode the index value of the transform kernel of the current block, and write obtained encoding bits into the bitstream.

It can be understood that in the embodiments of the present application, the “unit” may be a part of a circuit, a part of a processor, a part of a program or software, etc., or, it may also be a module, or it may also be non-modular. Moreover, in this embodiment, each component may be integrated in one processing unit, or each unit may physically exist separately, or two or more units may be integrated in one unit. The above-described integrated unit may be implemented in the form of hardware or software functional modules.

Based on the understanding that the integrated unit may be stored in a computer-readable storage medium when implemented in the form of a software functional module and not sold or used as an independent product, the technical solution of the present embodiment essentially or contributing to the prior art or all or part of the technical solution may be embodied in the form of a software product stored in a storage medium comprising several instructions for causing a computer device (which may be a personal computer, a server, a network device, etc.) or a processor to perform all or part of the steps of the method of the present embodiment. The storage medium includes a USB disk, a removable hard disk, a Read Only Memory (ROM), a Random Access Memory (RAM), a magnetic disk, an optical disk, and various media capable of storing program codes.

Accordingly, the embodiments of the present application provide a computer-readable storage medium applied to the encoder 220. The computer-readable storage medium stores a computer program that, when executed by a first processor, implements the method of any of the preceding embodiments.

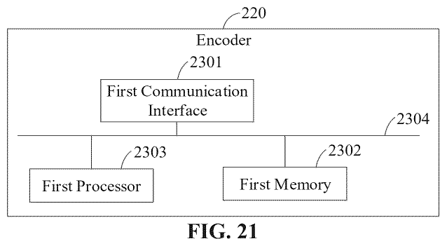

Based on the configuration of the encoder 220 and the computer-readable storage medium, reference is made to FIG. 21, which shows a schematic diagram of a specific hardware structure of the encoder 220 according to an embodiment of the present application. As shown in FIG. 21, the encoder 220 may include: a first communication interface 2301, a first memory 2302, and a first processor 2303. The various components are coupled together via a first bus system 2304. It will be appreciated that the first bus system 2304 is used to enable connected communication between these components. The first bus system 2304 includes a power bus, a control bus, and a status signal bus in addition to a data bus. However, for the sake of clarity of illustration, various buses are designated as first bus system 2304 in FIG. 21.

The first communication interface 2301 is configured to receive or transmit signals in the process of transmitting or receiving information with other external network elements.

The first memory 2302 is configured to store a computer program executable on the first processor 2303.

The first processor 2303 is configured, while executing the computer program, to perform the following operations:
determining a target filtering mode for a current block;
determining a reference region for the current block according to a size parameter of the current block and the target filtering mode;
determining filtering coefficients for the current block according to the reference region for the current block; and
intra predict the current block according to the filtering coefficients to determine prediction values of the current block.

It is understood that the first memory 2302 in the embodiment of the present application may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and Direct Rambus RAM (DRRAM). The first memory 2302 of the systems and methods described herein is intended to include, but is not limited to, these and any other suitable type of memory.

The first processor 2303 may be an integrated circuit chip having signal processing capabilities. In implementation, the steps of the above method may be completed by an integrated logic circuit of hardware in the first processor 2303 or instructions in the form of software. The above-described first processor 2303 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present application may be implemented or executed. The general purpose processor may be a microprocessor or the processor may be any traditional processor or the like. The steps of the method disclosed in connection with the embodiments of the present application may be directly embodied as execution by the hardware decoding processor, or may be executed by combining hardware and software modules in the decoding processor. The software module may be located in a storage medium mature in the art such as a random memory, a flash memory, a read-only memory, a programmable read-only memory, an electrically erasable programmable memory, registers, etc. The storage medium is located in the first memory 2302, and the first processor 2303 reads the information in the first memory 2302, and completes the steps of the above method in combination with its hardware.

It will be appreciated that the embodiments described herein may be implemented in hardware, software, firmware, middleware, microcode, or a combination thereof. For hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general purpose processors, controllers, microcontrollers, microprocessors, other electronic units for performing the functions described herein, or combinations thereof. For software implementations, the techniques described herein may be implemented by modules (e.g., procedures, functions, etc.) that perform the functions described herein. The software code may be stored in memory and executed by a processor. The memory may be implemented in the processor or external to the processor.

Optionally, as another embodiment, the first processor 2303 is further configured to: when executing the computer program, perform the method of any one of the preceding embodiments.

The present embodiment provides an encoder, the encoder determines a reference region for calculating a filtering coefficient based on an interpolation filtering-based intra prediction technique, the determination of the reference region is related not only to a target filtering mode but also to a size parameter of a current block. For example, a large reference region may be used when the size of the current block is large, and a small reference region may be used when the size of the current block is small. In this way, the computational complexity can be reduced and the encoding time can be reduced. At the same time, the accuracy of intra prediction can also be improved, thereby improving the coding and decoding performance.

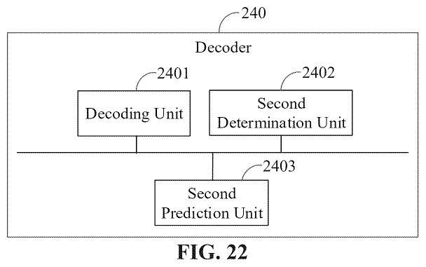

In yet another embodiment of the present application, based on the same inventive concept as the above embodiments, reference is made to FIG. 22, which shows a schematic structural diagram of the configuration of a decoder according to the embodiment of the present application. As shown in FIG. 22, the decoder 240 may include a decoding unit 2401, a second determination unit 2402, and a second prediction unit 2403.

The decoding unit 2401 is configured to decode a bitstream to determine a target filtering mode for a current block.

The second determination unit 2402 is configured to determine a reference region for the current block according to a size parameter of the current block and the target filtering mode.

The second prediction unit 2403 is configured to determine filtering coefficients for the current block according to the reference region for the current block; and intra predict the current block according to the filtering coefficients to determine prediction values of the current block.

In some embodiments, the target filtering mode includes a type of the reference region for the current block and a shape of a target filter.

In some embodiments, the second determination unit 2402 is further configured to: when the type of the reference region for the current block is a first type, determine that the reference region for the current block includes a top neighboring region and a left neighboring region; when the type of the reference region for the current block is a second type, determine that the reference region for the current block includes the top neighboring region; when the type of the reference region for the current block is a third type, determine that the reference region for the current block includes the left neighboring region. The top neighboring region refers to a reconstructed region neighboring to a top side of the current block, and the left neighboring region refers to a reconstructed region neighboring to a left side of the current block.

In some embodiments, the size parameter of the current block includes a height and width of the current block. The second determination unit 2402 is further configured to determine a minimum parameter from the height and the width of the current block; and determine the reference region for the current block according to the minimum parameter and the target filtering mode.

In some embodiments, a size of the reference region for the current block is associated with the shape of the target filter and the minimum parameter.

In some embodiments, the second determination unit 2402 is further configured to: when a multiple of the width of the current block and a first factor is less than the height of the current block, determine that the type of the reference region in the target prediction mode is any type other than the second type; when a multiple of the height of the current block and the first factor is less than the width of the current block, determine that the type of the reference region in the target prediction mode is any type other than the third type.

In some embodiments, the value of the first factor is a first preset constant.

In some embodiments, the second determination unit 2402 is further configured to determine a context model for the current block.

The decoding unit 2401 is further configured to decode the bitstream based on the context model and determine the target filtering mode for the current block.

In some embodiments, the determination of the context model is associated with at least one of the following parameters:
the shape of the current block; or
the ratio of width to height of the current block.

In some embodiments, the second determination unit 2402 is further configured to determine input values of the target filter and output values of the target filter corresponding to at least one reference sample in the reference region, according to the reference region for the current block and a shape of a target filter; determine an autocorrelation coefficient matrix according to the input values of the target filter corresponding to the at least one reference sample; determine a cross-correlation coefficient vector according to the input values of the target filter and the output values of the target filter corresponding to the at least one reference sample; determine coefficients for the target filter according to the autocorrelation coefficient matrix and the cross-correlation coefficient vector; and determine the coefficients for the target filter as the filtering coefficients for the current block.

In some embodiments, the second prediction unit 2403 is further configured to determine values of reference samples corresponding to a sample to be predicted in the current block; and determine a prediction value of the sample to be predicted in the current block according to the values of the reference samples corresponding to the sample to be predicted in the current block and the filtering coefficients.

In some embodiments, the second determination unit 2402 is further configured to: based on the shape of the target filter, when a reference sample is located in the reference region for the current block, determine a reconstructed value at a position corresponding to the reference sample in the reference region as a value of the reference sample; when a reference sample is located inside the current block, determine a prediction value at a position corresponding to the reference sample in the current block as a value of the reference sample.

In some embodiments, the second prediction unit 2403 is further configured to determine first input values of the target filter based on the values of the reference samples corresponding to the sample to be predicted in the current block; determine a first output value of the target filter based on the first input values and the filtering coefficients; and determine the prediction value of the sample to be predicted in the current block according to the first output value.

In some embodiments, the second determination unit 2402 is further configured to determine a second factor; and perform a subtraction operation on the values of the reference samples and the second factor to obtain the first input values of the target filter.

In some embodiments, the second determination unit 2402 is further configured to determine a second output value of the target filter based on the first input values and the filtering coefficients; and perform first processing on the second output value to determine the first output value of the target filter.

In some embodiments, the second determination unit 2402 is further configured to calculate products of the first input values and corresponding filtering coefficients; and set the second output values of the target filter equal to a sum of n products, where n represents a number of input terms corresponding to the target filter, and n is a positive integer.

In some embodiments, the second determination unit 2402 is further configured to add the second output value and the second factor to obtain the first output value of the target filter.

In some embodiments, the second determination unit 2402 is further configured to determine a third output value of the target filter; determine a fourth output value of the target filter according to the second output value and the third output value; and add the fourth output value and the second factor to obtain the first output value of the target filter.

In some embodiments, the second determination unit 2402 is further configured to determine a number of first-type input terms corresponding to the target filter based on the shape of the target filter; when the number of first-type input terms corresponding to the target filter is p, determine p+q filtering coefficients for the target filter, where p and q are positive integers; and determine the third output value of the target filter according to q filtering coefficients among the p+q filtering coefficients and q second-type input terms.

In some embodiments, the second determination unit 2402 is further configured to determine a number of first-type input terms corresponding to the target filter based on the shape of the target filter; when the number of first-type input terms corresponding to the target filter is p, determine p+m filtering coefficients for the target filter, where p and m are positive integers; and determine the third output value of the target filter according to m filtering coefficients among the p+m filtering coefficients and m third-type input terms.

In some embodiments, the second determination unit 2402 is further configured to determine a number of first-type input terms corresponding to the target filter based on the shape of the target filter; when the number of first-type input terms corresponding to the target filter is p, determining p+k filtering coefficients for the target filter, where p and k are positive integers; determine the third output value of the target filter according to i filtering coefficients among the p+k filtering coefficients, i second-type input terms, j filtering coefficients among the p+k filtering coefficients and j third-type input terms, where i and j are positive integers, and k=i+j.

In some embodiments, the first-type input terms have a linear relationship with the values of the reference samples, the second-type input terms have a nonlinear relationship with the values of the reference samples, and the third-type input terms are preset bias information.

In some embodiments, the value of the second factor is a second preset constant.

In some embodiments, the second determination unit 2402 is further configured to determine reconstructed values of one or more reference samples in the reference region; calculate a mean of the reconstructed values of the one or more reference samples to obtain a first mean; and set a value of the second factor equal to the first mean.

In some embodiments, the second prediction unit 2403 is further configured to perform second processing on the first output value to obtain the prediction value of the sample to be predicted in the current block.

In some embodiments, the second prediction unit 2403 is further configured such that the second processing is to set the prediction value of the sample to be predicted in the current block equal to the first output value.

In some embodiments, the second prediction unit 2403 is further configured such that the second process is to limit the first output value within a preset value range, herein a lower limit value of the preset value range is a minimum reconstructed value in the reference region, and an upper limit value of the preset value range is a maximum reconstructed value in the reference region.

In some embodiments, the second determination unit 2402 is further configured to: when intra prediction based on the filtering coefficients is used for a luma component of the current block, determine a derivation intra prediction mode for the luma component of the current block; when intra prediction in a direct mode is used for a chroma component of the current block, set a direct mode as the derivation intra prediction mode to determine prediction values of the chroma component of the current block.

In some embodiments, the second determination unit 2402 is further configured to when the current block meets a preset condition, determine a reference block for the current block; if intra prediction based on the filtering coefficients is used for the reference block, determine a derivation intra prediction mode for the reference block; and add the derivation intra prediction mode to an intra prediction mode candidate list for the current block.

In some embodiments, the current block meeting a preset condition includes at least one of the following:
the current block is an inter prediction block; or
the current block is an intra block copy (IBC) block.

In some embodiments, the decoding unit 2401 is further configured to decode the bitstream to determine residual values of the current block.

The second determination unit 2402 is further configured to determine reconstructed values of the current block based on the prediction values of the current block and the residual values of the current block.

In some embodiments, the decoding unit 2401 is further configured to decode the bitstream to determine quantized coefficients of the current block; performing inverse quantization processing on the quantized coefficients to obtain transform coefficients of the current block; and performing inverse transform processing on the transform coefficients to obtain the residual values of the current block.

In some embodiments, the decoding unit 2401 is further configured to when a multiple transform selection mode is used for the current block and a target filtering mode is an interpolation filtering mode, determine a target transform kernel for the current block; and perform the inverse transform processing on the transform coefficients according to the target transform kernel, to obtain the residual values of the current block.

In some embodiments, the determination of the target transformation kernel is associated with at least one of the following parameters:
the target filtering mode for the current block;
the size parameter of the current block; or
a shape of the current block.

In some embodiments, the decoding unit 2401 is further configured to decode the bitstream to determine an index value of a transform kernel for the current block;

The second determination unit 2402 is further configured to determine the target transform kernel for the current block from one or more candidate transform kernels according to the index value of the transform kernel.

In some embodiments, the decoding unit 2401 is further configured to decode the bitstream to determine an index value of a transform kernel for the current block.

The second determination unit 2402 is further configured to determine the target transform kernel for the current block from one or more candidate transform kernels according to the index value of the transform kernel and the size parameter of the current block.

In some embodiments, the second determination unit 2402 is further configured to decode the bitstream to determine information of non-zero coefficients for the current block.

The second determination unit 2402 is further configured to determine the one or more candidate transform kernels according to the information of the non-zero coefficients for the current block.

In some embodiments, the number of one or more candidate transform kernels is less than or equal to 6.

It will be understood that, in this embodiment, the “unit” may be part of a circuit, part of a processor, part of a program or software, etc., or, it may also be a module, or it may also be non-modular. Moreover, in this embodiment, each component may be integrated in one processing unit, each unit may physically exist separately, or two or more units may be integrated in one unit. The above-described integrated unit may be implemented in the form of hardware or software functional modules.

The integrated unit may be stored in a computer-readable storage medium when implemented in the form of software functional modules and not marketed or used as a stand-alone product. Based on such an understanding, the present embodiment provides a computer-readable storage medium applied to the decoder 240, the computer-readable storage medium storing a computer program that, when executed by a second processor, implements the method of any of the preceding embodiments.

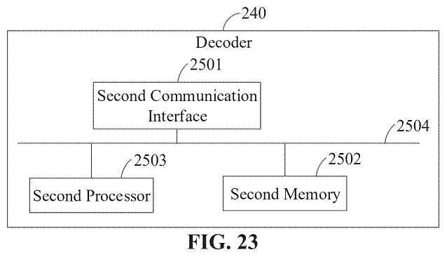

Based on the configuration of the decoder 240 and the computer-readable storage medium, reference is made to FIG. 23, which shows a schematic diagram of a specific hardware structure of the decoder 240 according to an embodiment of the present application. As shown in FIG. 23, the decoder 240 may include: a second communication interface 2501, a second memory 2502, and a second processor 2503. The various components are coupled together via a second bus system 2504. It will be appreciated that the second bus system 2504 is used to enable connected communication between these components. The second bus system 2504 includes a power bus, a control bus, and a status signal bus in addition to a data bus. However, for the sake of clarity of illustration, various buses are designated as second bus system 2504 in FIG. 23.

The second communication interface 2501 is configured to receive or transmit signals in the process of transmitting or receiving information with other external network elements.

The second memory 2502 is configured to store a computer program executable on the second processor 2503.

The second processor 2503 is configured to, when execute the computer program, performs the following operations:
decoding a bitstream to determine a target filtering mode for a current block;
determining a reference region for the current block according to a size parameter of the current block and the target filtering mode;
determining filtering coefficients for the current block according to the reference region for the current block; and
intra predict the current block according to the filtering coefficients to determine prediction values of the current block.

Optionally, as another embodiment, the second processor 2503 is further configured to: when executing the computer program, perform the method of any of the preceding embodiments.

It will be appreciated that the second memory 2502 is similar in hardware functionality to the first memory 2302 and the second processor 2503 is similar in hardware functionality to the first processor 2303. It will not be detailed here.

The present embodiment provides a decoder. The decoder determines a reference region for calculating a filtering coefficient based on an interpolation filtering-based intra prediction technique. The determination of the reference region is related not only to a target filtering mode but also to a size parameter of a current block. For example, a large reference region may be used when the size of the current block is large, and a small reference region may be used when the size of the current block is small. In this way, the computational complexity can be reduced, and at the same time, the accuracy of intra prediction can be improved, thereby improving the codec performance.

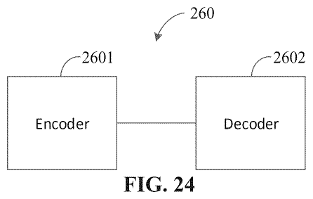

In yet another embodiment of the present application, reference is made to FIG. 24, which shows a schematic structure diagram of a codec system according to an embodiment of the present application. As shown in FIG. 24, the codec system 260 may include an encoder 2601 and a decoder 2602.

In an embodiment of the present application, the encoder 2601 may be the encoder described in any one of the foregoing embodiments, and the decoder 2602 may be the decoder described in any one of the foregoing embodiments.

It should be noted that, in the present application, the terms “comprising”, “including”, or any other variation thereof are intended to encompass a non-exclusive inclusion such that a process, method, article, or apparatus comprising a series of elements includes not only those elements, but also other elements not explicitly listed, or elements inherent to such a process, method, article, or apparatus. Without further limitation, an element defined by the statement “comprising a” does not preclude the presence of additional identical elements in a process, method, article, or apparatus that includes the element.

The above-described serial numbers of the embodiments of the present application are for description only, and do not represent the advantages and disadvantages of the embodiments.

The methods disclosed in several method embodiments provided herein can be arbitrarily combined without conflict to obtain new method embodiments.

The features disclosed in several product embodiments provided herein can be arbitrarily combined without conflicting to obtain new product embodiments.

Features disclosed in several methods or apparatus embodiments provided herein can be arbitrarily combined without conflict to obtain new method or apparatus embodiments.

The above is only a specific embodiment of the present application, but the scope of protection of the present application is not limited thereto. Changes or substitutions which are easily thought by any person skilled in the art within the technical scope disclosed in the present application should be covered within the scope of protection of the present application. Therefore, the scope of protection of the present application should be based on the scope of protection of the claims.

### INDUSTRIAL PRACTICALITY

In the embodiments of the present application, whether at the encoding side or the decoding end, after determining a target filtering mode for the current block, a reference region for the current block is determined according to a size parameter of the current block and the target filtering mode. Then, filtering coefficients for the current block are determined according to the reference region for the current block. Next, intra prediction is performed o the current block according to the filtering coefficients to determine prediction values of the current block. In this way, the interpolation filtering-based intra prediction technique is used to determine the reference region for calculating the filtering coefficients, the determination of the reference region is related to not only the target filtering mode but also the size parameter of the current block. For example, a large reference region may be used when the size of the current block is large, and a small reference region may be used when the size of the current block is small. In this way, while ensuring the encoding and decoding performance, the computational complexity and the encoding time can be reduced, so that a ratio of the encoding and decoding performance to the encoding complexity can be improved, and at the same time, the intra prediction accuracy can be improved, thereby improving the encoding and decoding efficiency.

1. A decoding method, applied to a decoder, comprising:
decoding a bitstream to determine a target filtering mode for a current block;
determining a reference region for the current block according to a size parameter of the current block and the target filtering mode;
determining filtering coefficients for the current block according to the reference region for the current block; and
determining intra prediction values of the current block based on the filtering coefficients.

2. The method of claim 1, wherein the target filtering mode comprises at least one of a type of the reference region for the current block or a shape of a target filter for the current block.

3. The method of claim 2, further comprising:
when the type of the reference region for the current block is a first type, determining that the reference region for the current block comprises a top neighboring region and a left neighboring region;
when the type of the reference region for the current block is a second type, determining that the reference region for the current block comprises the top neighboring region;
when the type of the reference region for the current block is a third type, determining that the reference region for the current block comprises the left neighboring region;
wherein the top neighboring region refers to a reconstructed region neighboring to a top side of the current block, and the left neighboring region refers to a reconstructed region neighboring to a left side of the current block.

4. The method of claim 2, wherein the size parameter of the current block comprises a height and a width of the current block; and determining the reference region for the current block based on the size parameter of the current block and the target filtering mode comprises:
determining a minimum parameter from the height and the width of the current block; and
determining the reference region for the current block according to the minimum parameter and the target filtering mode.

5. The method of claim 4, wherein determining the reference region for the current block according to the minimum parameter and the target filtering mode comprises:
determining the reference region for the current block according to the minimum parameter and the type of the reference region for the current block.

6. The method of claim 4, wherein determining the reference region for the current block according to the minimum parameter and the target filtering mode comprises:
determining the reference region for the current block according to the minimum parameter and the shape of the target filter for the current block.

7. The method of claim 3, further comprising:
when a multiple of the width of the current block and a first factor is less than the height of the current block, determining that the type of the reference region in the target prediction mode is any type other than the second type;
when a multiple of the height of the current block and the first factor is less than the width of the current block, determining that the type of the reference region in the target prediction mode is any type other than the third type.

8. The method of claim 1, wherein decoding the bitstream to determine the target filtering mode for the current block comprises:
determining a context model for the current block; and
decoding the bitstream based on the context model to determine the target filtering mode for the current block.

9. The method of claim 8, wherein the determination of the context model is associated with at least one of the following parameters:
a shape of the current block; or
a ratio of a width to a height of the current block.

10. The method of claim 2, wherein determining the filtering coefficients for the current block according to the reference region for the current block comprises:
determining input values of the target filter and output values of the target filter corresponding to at least one reference sample in the reference region, according to the reference region for the current block and a shape of a target filter;
determining an autocorrelation coefficient matrix according to the input values of the target filter corresponding to the at least one reference sample;
determining a cross-correlation coefficient vector according to the input values of the target filter and the output values of the target filter corresponding to the at least one reference sample;
determining coefficients for the target filter according to the autocorrelation coefficient matrix and the cross-correlation coefficient vector; and
determining the coefficients for the target filter as the filtering coefficients for the current block.

11. The method of claim 1, further comprising:
when intra prediction based on the filtering coefficients is used for a luma component of the current block, determining a derivation intra prediction mode for the luma component of the current block;
when intra prediction in a direct mode is used for a chroma component of the current block, setting a direct mode as the derivation intra prediction mode to determine prediction values of the chroma component of the current block.

12. The method of claim 11, wherein
when the intra prediction based on the filtering coefficients is used for the luma component of the current block, determining that the derivation intra prediction mode for the luma component of the current block is a PLANAR mode or determining the derivation intra prediction mode for the luma component of the current block by constructing a gradient histogram;
when the intra prediction in the direct mode is used for the chroma component of the current block, setting the direct mode as the derivation intra prediction mode to determine prediction values of the chroma component of the current block.

13. The method of claim 1, further comprising:
decoding the bitstream to determine quantized coefficients of the current block;
performing inverse quantization processing on the quantized coefficients to obtain transform coefficients of the current block; and
performing inverse transform processing on the transform coefficients to obtain the residual values of the current block.

14. The method of claim 13, wherein the performing the inverse transform processing on the transform coefficients to obtain the residual values of the current block comprises:
when a multiple transform selection mode is used for the current block and a target filtering mode is an interpolation filtering mode, determining a target transform kernel for the current block; and
performing the inverse transform processing on the transform coefficients according to the target transform kernel, to obtain the residual values of the current block.

15. The method of claim 14, wherein the determination of the target transform kernel is associated with at least one of the following parameters:
the target filtering mode for the current block;
the size parameter of the current block; or
a shape of the current block.

16. The method of claim 14, wherein determining the target transform kernel for the current block comprises:
determining an index value of a transform kernel for the current block; and
determining the target transform kernel for the current block from one or more candidate transform kernels according to the index value of the transform kernel; or
determining the target transform kernel for the current block from one or more candidate transform kernels according to the index value of the transform kernel and the size parameter of the current block.

17. The method of claim 16, further comprising:
decoding the bitstream to determine information of non-zero coefficients for the current block; and
determining the one or more candidate transform kernels according to the information of the non-zero coefficients for the current block.

18. The method of claim 17, wherein determining the one or more candidate transform kernels according to the information of the non-zero coefficients for the current block comprising:
determining a number of the one or more candidate transform kernels according to the information of the non-zero coefficients for the current block.

19. An encoding method, applied to an encoder, comprising:
determining a target filtering mode for a current block;
determining a reference region for the current block according to a size parameter of the current block and the target filtering mode;
determining filtering coefficients for the current block according to the reference region for the current block; and
determining intra prediction values of the current block based on the filtering coefficients.

20. A non-transitory computer-readable storage medium, having a computer program and a bitstream stored thereon, wherein the computer program, when executed by a processor, enables the processor to perform the following operations to generate the bitstream:
determining a target filtering mode for a current block;
determining a reference region for the current block according to a size parameter of the current block and the target filtering mode;
determining filtering coefficients for the current block according to the reference region for the current block; and
determining intra prediction values of the current block based on the filtering coefficients.
